(19) United States
(12) Patent Application Publication
(10) Pub. No.: US 2024/0384090 A1
(43) Pub. Date: Nov. 21, 2024

(54) DYNAMICALLY CROSSLINKED AND TOUGH POLYMER COMPOSITES WITH RECYCLING ABILITY

(71) Applicant: UT-Battelle, LLC, Oak Ridge, TN (US)

(72) Inventors: Md Anisur Rahman, Knoxville, TN (US); Tomonori Saito, Knoxville, TN (US); Menisha M. Koralalage, Oak Ridge, TN (US)

(21) Appl. No.: 18/665,880

(22) Filed: May 16, 2024

Related U.S. Application Data
(60) Provisional application No. 63/467,026, filed on May 17, 2023.

(51) Int. Cl. C08L 53/00; C08J 3/24; C08K 3/04; C08K 5/053; C08K 7/06; C08K 7/14; C08K 9/04; C08L 23/08; C08L 23/22; C08L 25/08

(52) U.S. Cl. CPC C08L 53/005; C08J 3/24; C08K 3/04; C08K 5/053; C08K 7/06; C08K 7/14; C08K 9/04; C08L 23/08; C08L 23/22; C08L 25/08; C08J 2353/00; C08L 2207/20; C08L 2312/00

(57) ABSTRACT

A dynamically crosslinked polymer composite material comprising: (i) a polymer containing boronic acid or boronic ester groups; and (ii) a solid filler embedded within the polymer, wherein surfaces of the solid filler are functionalized with hydroxy groups; wherein the hydroxy groups on surfaces of the solid filler engage in dynamic crosslinking with the boronic acid or ester groups in the polymer. The composite material may further include: (iii) polyol crosslinking molecules containing at least three hydroxy groups per polyol crosslinking molecule; wherein the hydroxy groups in the polyol crosslinking molecules engage in dynamic crosslinking with the boronic acid or ester groups on the polymer, in addition to hydroxy groups on surfaces of the solid filler engaging in dynamic crosslinking with the boronic acid or ester groups on the polymer.

### CROSS-REFERENCE TO RELATED APPLICATIONS

The present application claims benefit of U.S. Provisional Application No. 63/467,026, filed May 17, 2023, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to polymeric composites designed to be tough and robust. The present invention also generally relates to polymeric composites designed to be recyclable. The invention more particularly relates to dynamic crosslinked polymeric composites containing boronate linkages, wherein the boronate linkages provide a dynamic covalent bonding characteristic.

### BACKGROUND

Carbon fiber-reinforced polymers (CFRPs) offer robust mechanical properties with their excellent strength-to-weight ratio (e.g., superior stiffness and strength), and are much lighter than metal alternatives, thus permitting highly efficient energy usage in automobiles, wind power conversion, and aerospace applications. CFRPs are critical structural materials for achieving net-zero carbon goals because of their lighter weight, and their utilization in transportation can lower fuel consumption and carbon emissions. For example, the incorporation of lightweight materials in passenger vehicles can improve fuel efficiency by 6-8% by reducing overall vehicle weight by 10% (P. R. Barnett et al., Composites Part C: Open Access 2021, 4, 100092).

The demand for lightweight CFRPs is growing rapidly in various industries ranging from transportation to sporting goods, even though the cost of CFs is comparatively higher than that of metals. However, the increasing production and rapid adoption of CFRPs have been accompanied by numerous challenges, including weak interfacial adhesion, easy delamination, poor polymer-fiber miscibility, and waste management. Epoxy-based permanently crosslinked thermoset polymers, in particular, are typically used to make CFRPs as matrix due to their high structural properties, but those conventional thermoset-based CFRPs suffer from high manufacturing processing time, relatively high costs, poor malleability, and lack of repairability and recyclability, the latter of which generates a very large amount of CFRP waste after their service life. The projected annual global waste of CFRPs is expected to reach 20 kt by 2025 (J. Zhang et al., Composites Part B: Engineering 2020, 193, 108053). Approximately 38,000 tons of CFRP waste is expected to be generated annually after 2030 when the wind turbine blades' service life will end (X. Ma et al., ACS Macro Letters 2021, 10(9), 1113-1118).

Moreover, production of pristine CF is an expensive and energy-intensive process (˜198-595 MJ/kg) that has negative impacts on the environment as it emits a large amount of CO₂ (F. Meng et al., ACS Sustainable Chemistry & Engineering 2018, 6(8), 9854-9865). Therefore, recycling of CFs and CFRPs, if achieved, could significantly reduce energy consumption and carbon footprint and also address emerging environmental concerns. While some advances have been made in recycling CFRPs by mechanical, thermal, and chemical approaches, most of them involve high energy consumption, have difficulty in recovering both fiber and resin, and generally result in lower-value materials. Therefore, developing energy-efficient, eco-friendly closed-loop recycling of CFRPs with minimum impact on the fibers' strength and enhancing interfacial compatibility are critically needed for establishing carbon neutrality and circular manufacturing of lightweight composite materials for automotive and other industries.

Moreover, the mechanical properties of CFRPs depend not only on the reinforcing materials or matrices alone but also are dictated by the interface of good bonding between the fibers and matrix (F. Vautard et al., Composites Part A: Applied Science and Manufacturing 2012, 43(7), 1120-1133). The low surface energy and amphiphobic nature of CFs make them difficult for CFs to be wetted or chemically bonded to the majority of polymer matrices. Due to the lack of fiber-matrix interfacial adhesion, most of the existing CFRPs suffer from delamination between fibers and polymer matrices leading to sudden mechanical failure (H. Yuan et al., Applied Surface Science 2012, 259, 288-293). The most widely used strategy to improve interfacial adhesion between fibers and polymer matrices is the surface modification of CFs by numerous techniques, such as oxidation, plasma treatment, and fiber sizing or coating. The surface modifications can increase the oxygen content or other functional groups, which can interact with polymer matrices mostly through physical interactions. However, most of the techniques rely on energy-intensive processes which often damage the CFs and reduce their mechanical properties.

### SUMMARY

In a primary aspect, the present disclosure provides a novel crosslinked polymer composite with dynamic crosslinking interactions that impart toughness, exceptional strength, and ductility, along with reprocessability and recyclability. The present disclosure is particularly directed to tough reversible/recyclable polymer composite materials containing dynamic crosslinking interactions between boronic acid or ester groups of a polymer and a filler material containing hydroxy groups on its surface. The polymer, which is functionalized with boronic acid or boronic ester groups, may be, for example, polystyrene-based, vinyl-based, methacrylate-based, or acrylate-based. In particular embodiments, the polymer is a copolymer of polystyrene and contains boronic acid or ester groups, or more particularly, the polymer is a copolymer of polystyrene and a polyolefin, wherein the polyolefin may be, e.g., polyethylene, polypropylene, polybutylene, polybutadiene, polyisoprene, or a copolymer or combination thereof. The filler, which contains hydroxy groups either directly or indirectly bound to its surface, may be, for example, carbon fiber (woven or non-woven), metal oxide, glass fiber (woven or non-woven), basalt fiber (woven or non-woven), a solid biopolymer material (e.g., cellulose), or an artificial polymeric composition. In the polymer composites described herein, the hydroxy groups on surfaces of the filler material engage in dynamic crosslinking with the boronic acid or ester groups on the polymer to impart exceptional strength, toughness, and recyclability to the composite.

In further embodiments, polyol crosslinking molecules containing at least three, four, five, or six hydroxy groups per polyol crosslinking molecule are included in the polymer composite, wherein the hydroxy groups in the polyol crosslinking molecules engage in dynamic crosslinking with the boronic acid or ester groups on the polymer, which is in addition to hydroxy groups on surfaces of the solid filler engaging in dynamic crosslinking with the boronic acid or ester groups on the polymer. The polyol crosslinking molecules may be present in an amount of, for example, 1-50 mol %, 1-20 mol %, 1-10 mol %, or 1-5 mol % of boronic acid or ester groups. In separate or further embodiments, the polyol crosslinking molecules have a molecular weight of up to, no more than, or less than 5000 g/mol, 4000 g/mol, 3000 g/mol, 2000 g/mol, or 1500 g/mol. In other embodiments, the polyol crosslinking molecules have a molecular weight of at least or above any of the foregoing molecular weights.

Due to the lack of fiber-matrix interfacial adhesion, most existing CFRPs, including commercial epoxies, suffer from delamination between fibers and polymer matrices, leading to sudden mechanical failure. Hole drilling CFRPs for aircraft manufacturing wing spars and mechanical fasteners in automobiles is notoriously tricky to manufacture without delamination. Herein, CF surfaces were functionalized with dynamic covalent bonds forming functional groups, such as, for example, diol groups, to covalently bind with the boronic ester group containing vitrimer resins. The dynamic covalent bonding between the fiber surface and the matrix increases the interfacial adhesion as well as the overall mechanical properties of CFRPs.

Another advantage of the polymer composites described herein is the closed-loop recyclability of both the vitrimer polymer and carbon fibers. In this respect, a commodity polymer may be upcycled (i.e., converted) to a vitrimer containing dynamic boronic acid or ester groups and optionally combined with polyol crosslinker. Because of the reversible dynamic nature of the boronic ester network, both resin and carbon fibers can be easily recycled and recovered without deteriorating their performance. In the presence of excess pinacol, the vitrimer can be dissolved into THF or other organic solvent, as appropriate, where the dynamic boronic ester exchange reaction can reoccur between crosslinked boronic ester bonds and diol groups of pinacol. Thus, these composites can be used in applications where a substantial amount of non-recyclable waste of CFs/CFRPs is otherwise produced after their lifetime ends, such as in wind turbine blades.

The polymer composites described herein are also remarkably strong, typically exhibiting high tensile stress, modulus, and interfacial adhesion. In some cases, the polymer composites exhibit a substantially higher ultimate tensile strength, modulus, and/or toughness compared to the conventional epoxy. Therefore, these materials are particularly useful in applications requiring higher mechanical performances, such as aerospace/automotive body parts and wind turbine blades.

The polymer composites described herein may also be used as adhesives. In particular embodiments, the polymer composites can function as self-adhesives when hot-pressed at 200° C. for 10 minutes, which significantly mitigates the existing challenges associated with conventional external adhesives and also results in a substantial cost saving. This feature may be particularly desired in applications where the composite parts must self-adhere to each other, such as in the fabrication of a chassis in an automobile.

The polymer composites described herein are also advantageously repairable or healable. These new CFRVs can be repaired and reprocessed under heat due to the presence of the dynamic boronic ester bonds. Boronic ester bonds with diol crosslinkers can rearrange the network integrity under a specific temperature (e.g., about 200° C.), thus permitting the repair of microcracks within the composite matrix. In addition, these vitrimer-based CFRPs also exhibit fast thermoformability and can be molded or reshaped into any desired three-dimensional shape.

The superior properties of the polymer composites described herein make them useful in a number of commercial applications. Some of these applications include: (i) automotive parts, such as radiator supports, bumper beams, fenders, hoods, roof panels, deck lids, and other exterior and interior body components; (ii) aerospace components, including wing spars and fuselage components; (iii) sports equipment, such as used in tennis, squash, and badminton racquets, high-quality arrow shafts, hockey sticks, fishing rods, surfboards, and rowing shells; (iv) tools, such as hammers, screw drivers, drills, wrenches, and pliers; and (v) structural applications, such as wind turbine blades, musical instruments, high-performance drone bodies, other radio-controlled vehicles, aircraft components (e.g., helicopter rotor blades), laptop shells, and other high-performance cases.

### BRIEF DESCRIPTION OF THE DRAWINGS

FIGS. 1A-1B. A schematic illustration of vitrimer design and closed-loop recyclable carbon fiber-reinforced vitrimer (CFRV). FIG. 1A shows the design of a vitrimer resin by incorporating dynamic covalent bonds. FIG. 1B shows the design of a close-loop recyclable CFRV composite using sized carbon fiber with dynamic functional groups. The CFRV is mechanically robust, recyclable, stable in wide temperature windows, and exhibits strong fiber-matrix interfacial adhesion.

FIGS. 2A-2F. Design of dynamic boronic ester cross-linked vitrimers and their tailored mechanical and thermomechanical performance. FIG. 2A is a schematic illustration of the synthesis of multi-diol crosslinked vitrimer from modified SEBS (S-Bpin), and chemical structures of multi-diol crosslinkers. The mechanical properties of neat S-Bpin, crosslinked with diglycerol, bisphenol-diol, and tris-diol resins are demonstrated by dynamic mechanical analysis (DMA) curves of storage modulus as a function of temperature (FIG. 2B); tan delta versus temperature for S-Bpin and multi-diol_S-Bpin resins (FIG. 2C); the solvent resistance test of dynamic boronic ester crosslinked resins in tetrahydrofuran at room temperature for 24 hours, which demonstrates the crosslinking nature (FIG. 2D); representative tensile stress-strain curves from uniaxial elongation until failure (FIG. 2E), and toughness (FIG. 2F). The error bars indicate SDs from at least triplicate measurements.

FIGS. 3A-3I. Mechanical, thermomechanical behavior, and recyclability of tris-diol crosslinked vitrimers. The following data is shown for this vitrimer: stress-strain curves from uniaxial elongation until failure (FIG. 3A); toughness (FIG. 3B); dynamic mechanical analysis (DMA) of different tris-diol crosslinked samples in oscillation temperature increase from −120° to 300° C., with DMA curves of storage modulus (FIG. 3C); the loss factor (tan δ =E″/E′) recorded via the measurement in FIG. 3C (FIG. 3D); normalized stress relaxation curves of 5 mol % tris-diol crosslinked sample at a temperature range of 250 to 300° C. with 10° C. intervals (FIG. 3E); fitting of the relaxation times to the Arrhenius relation (R²-0.99755), wherein the deduced apparent activation energy Ea is ˜149 kJ/mol (FIG. 3F); schematic showing the thermal (re)processability of 5 mol % tris-diol crosslinked vitrimer (FIG. 3G); illustration of chemical recyclability of 5 mol % tris-diol-S-Bpin crosslinked vitrimer (FIG. 3H); and tensile stress and strain data obtained from thermally (re)processed and chemically recycled 5 mol % tris-diol crosslinked vitrimer (FIG. 31).

FIGS. 4A-4H. Carbon fiber functionalization. FIG. 4A is a synthetic scheme showing surface modification of woven CF. FIG. 4B is a fitted C1s XPS spectra of unsized-CF. FIG. 4C is a fitted C1s XPS spectra of diol-CF. FIG. 4D is a full scan of XPS spectra of unsized and diol-CF with XPS surface composition of unsized and diol-CF. FIG. 4E shows TGA data of unsized and diol-CF. FIG. 4F shows SEM images of unsized-CF and diol-CF, wherein the scale bar represents 5 μm. FIG. 4G shows K-cluster centroid spectra taken from different color-coded regions corresponding to FIG. 4H. FIG. 4H is a plot comparing the interfacial Raman spectra between sized CF/epoxy and unsized CF/epoxy.

FIGS. 5A-5F. Synthesis and mechanical properties of CFRPs. FIG. 5A is a synthetic scheme for producing a diol-CFRV composite, wherein the diol-functionalized CF was used not only as a reinforcing agent but also as a dynamic crosslinker. The following data is shown for this composite: tensile stress-strain curves of conventional CFRP and CFRV composites (FIG. 5B); comparison of tensile and young's modulus among controls and diol-CFRV composites (FIG. 5C); toughness (FIG. 5D); tensile stress-strain curves of 45-degree oriented CF composites to demonstrate the fiber matrix interactions (FIG. 5E); and comparison of interfacial toughness calculated from the area underneath the curve of tensile stress strain plots in FIG. 5E (FIG. 5F).

FIGS. 6A-6G. The thermoforming capability of cured CFRP. FIG. 6A are photographs showing the deformation of a rectangular CFRP composite heated to 200° C. and deformed into a “V” shape, which was retained at room temperature; wherein heating the “V”-shaped composite to 200° C. restored its rectangular shape. FIG. 6B are photographs of CFRP composites before and after self-adhering tests. FIG. 6C is a schematic showing chemical recycling of CF from CFRP composite in presence of pinacol and THF at 65° C. FIG. 6D are SEM images of the pristine and recycled CF of the tris diol-composite. FIG. 6E shows the full scan XPS spectra of unsized, diol-CF, and recycled CF composite. FIG. 6F is a plot of uniaxial tensile properties of diol-CFRP and chemically recycled CF. FIG. 6G is graph comparing tensile strength and Young's modulus of pristine CFRP and recycled CFRP composites.

FIG. 7. A schematic of the glass fiber reinforced vitrimer (GFRV) composite production process

FIGS. 8A-8D. FIGS. 8A and 8B are graphs showing the ultimate tensile strength and toughness, respectively, of GFRV composites. FIGS. 8C and 8D are graphs showing ultimate tensile strength and toughness, respectively, of 45-degree fiber-oriented GFRVs.

FIGS. 9A-9B. FIG. 9A schematically illustrates the overall closed-loop recycling process for GFRV composites. FIG. 9B is a graph showing the tensile stress-strain results of the recycled GFRV composites.

### DETAILED DESCRIPTION

In a first aspect, the present disclosure is directed to a dynamically crosslinked composite material (i.e., “composite material”) containing precisely or at least the following components: (i) a polymer containing boronic acid or boronic ester groups; and (ii) a solid filler embedded within the polymer, wherein surfaces of the solid filler are functionalized with hydroxy (OH) groups. In some embodiments, the crosslinked composite material further contains: (iii) polyol crosslinking molecules containing at least three, four, five, or six hydroxy groups per polyol crosslinking molecule. In the polymer composite, hydroxy groups on surfaces of the solid filler engage in dynamic crosslinking with the boronic acid or ester groups in the polymer. If polyol crosslinking molecules are present, they also engage in dynamic crosslinking with the boronic acid or boronic ester groups in the polymer.

As used herein, the term “boronic acid group” refers to groups of the formula —B(OH)₂ and the term “boronic ester group” refers to groups of the formula —B(OR)₂, wherein R represents a hydrocarbon group, and optionally, the two R groups may interconnect to form a cyclic boronic ester group. The term “boronate group” may be used herein to refer to either boronic acid or boronic ester groups or a combination of both groups.

The term “dynamically crosslinked,” as used herein, refers to a fluxional (reversible) bonding-unbonding process occurring in the polymer composite in which boronate groups on the polymer engage in intermittent transesterification with hydroxy-containing molecules in the composite. The hydroxy-containing molecules may be in crosslinking molecules and/or surfaces of the filler. For example, pinacolato-boronate groups on the polymer may engage with hydroxy-containing molecules, which may be polyol crosslinking molecules or hydroxy-containing molecules on the surface of the filler, to displace the pinacolate molecules (thus forming neutral protonated pinacol molecules) and replace them with deprotonated hydroxy-containing molecules that bond with the boron. Notably, the foregoing mechanism is part of a reversible alternating process in which the hydroxy-containing molecules exchange with pinacolate molecules on the boron.

The polymer containing boronic acid or boronic ester groups (i.e., component (i)) may be any type of polymer functionalized with boronate groups. The polymer, before being functionalized with boronate groups, may be any of a wide variety of polymers, including, for example, any of the thermoplastic or thermoset polymers of the art, any of which may be elastomeric or non-elastomeric. The polymer may also be a homopolymer or a copolymer, wherein the copolymer may be, for example, a block, alternating, random, brush, branched, or star copolymer and may be a binary, ternary, quaternary, or higher level copolymer. In more specific embodiments, the polymer may be a diblock, triblock, tetrablock, or higher block copolymer. The polymer contains the boronate groups in its backbone, or in pendant groups (e.g., pendant phenyl rings), or both. The polymer can have any suitable molecular weight (Mw), such as 1500 g/mol, 2000 g/mol, 3000 g/mol, 4000 g/mol, 5000 g/mol, 10,000 g/mol, 20,000 g/mol, 50,000 g/mol, 75,000 g/mol, 100,000 g/mol, 120,000 g/mol, or 150,000 g/mol or a Mw within a range bounded by any two of the foregoing values.

The polymer of component (i) may be, for example, any of the numerous boronate-functionalized polymers known in the art, such as described in, for example, W. L. A. Brooks and B. S. Sumerlin, Chem Rev., 116, 3, 1375-1397, 2015 and J. N. Cambre and B. S. Sumerlin, Polymer, 52(21), 4631-4643, 2011, the contents of which are herein incorporated by reference. A wide range of polymer types may be functionalized with boronate groups by known methods, such as described in, for example, G. Vancoillie and R. Hoogenboom, Polymer Chemistry, 7(35), 5484-5495, 2016, which is herein incorporated by reference. The polymer may more specifically be, for example, a vinyl-addition, polyester, polyurethane, polyamide, polysiloxane, polyaniline, or polyalkylene ether, or a copolymer of any of these types of polymers, any of which may be a homopolymer or a copolymer, wherein the copolymer may have any arrangement, such as, for example, a block, alternating, random, brush, or star polymer, and may contain two, three, or more types of polymer units. Typically, the boronate-containing polymer is uncharged (neutral). However, in some embodiments, the boronate-containing polymer may be positively or negatively charged.

In particular embodiments, the polymer is a vinyl-addition polymer, such as a polystyrene-based, methacrylate-based, acrylate-based, polyolefin-based (e.g., vinyl-based), acrylamide-based, acrylonitrile-based polymer, or a copolymer of any of these. For purposes of the invention, the foregoing classes or specific types of polymers are functionalized with boronate groups. The term “based,” as used herein, is meant to be synonymous with “containing.” Thus, a polystyrene-based polymer is meant to be synonymous with a polystyrene-containing polymer, which may be a homopolymer of polystyrene or a copolymer containing one or more polystyrene blocks (in the case of a block copolymer) or a multiplicity of styrene units (in the case of a non-block copolymer).

In particular embodiments, the polymer is polystyrene-based and contains boronic acid or boronic ester groups. In more particular embodiments, the polymer is a copolymer containing one or more polystyrene blocks (in the case of a block copolymer) or a multiplicity of styrene units (in the case of a non-block copolymer). In further embodiments, the copolymer may be a copolymer of polystyrene and a polyolefin, wherein the polyolefin may be, for example, polyethylene (polyvinyl), polypropylene, polybutylene, polybutadiene, or polyisoprene, or a combination thereof. In some embodiments, the polymer contains one or more ethylene, propylene, or butylene units (or blocks) in combination with one or more aromatic-containing units (or blocks). In some embodiments, the polymer is a triblock copolymer possessing a polystyrene-b-(poly-alkylene)-b-polystyrene structure, wherein the alkylene segment may be, for example, an ethylene, propylene, or butylene segment or a copolymeric segment thereof (e.g., ethylene-co-butylene, ethylene-co-propylene, or propylene-co-butylene). An example of such a copolymer is polystyrene-b-poly(ethylene-co-butylene)-b-polystyrene (SEBS). The copolymer may or may not also include one or more blocks of polyacrylonitrile or a multiplicity of acrylonitrile units, such as in ABS. In the case of an aromatic polymer or a copolymer containing aromatic blocks or units, the boronate groups may be attached to the aromatic rings in the polymer.

In some embodiments, the polymer contains olefinic units, such as ethylene (vinyl), propylene, or butylene units. The polymer may be, for example, a copolymer containing a polyethylene (PE), polypropylene (PP), polybutylene (PB), or polybutadiene (PBD) block (i.e., segment), or a homopolymer of PE, PP, PB, or PBD. In separate or further embodiments, the polymer contains one or more aromatic units, such as styrene, thiophene, vinylpyridine, phenylene, phenylene vinylene, or aniline units, such as by being a copolymer containing a polystyrene (PS), polythiophene (PT), poly(vinylpyridine), polyphenylene, polyphenylene vinylene, or polyaniline block, or by being a homopolymer of any of the foregoing. In some embodiments, the polymer contains at least both olefinic and aromatic units, which may be a specific combination selected from any of those disclosed above.

In other particular embodiments, the polymer is methacrylate-or acrylate-based and contains boronic acid or boronic ester groups. In more specific embodiments, the polymer may be, for example, poly (methyl methacrylate) with 3-aminophenylboronic acid moieties, or the polymer may be, for example, a homopolymer or copolymer containing poly(2-hydroxyethyl methacrylate) that has been functionalized with boronate groups. In other embodiments, the polymer is acrylamide-based and contains boronic acid or boronic ester groups. Examples of such polymers are provided in G. Vancoillie et al. (Ibid).

In some embodiments, the polymer, which may be any of the polymers described above, may be crosslinked. As well known, a polymer may be crosslinked by interconnecting at least two different locations of the polymer, typically via a crosslinker. In one embodiment, the polymer may be crosslinked via boronate linkages, i.e., in addition to boronate linkages connecting the polymer with the solid particles. Typically, in order for the polymer to be crosslinked by boronate linkages, an organic crosslinker connects between boronate linkages. In a typical crosslinking process, the polymer may be attached to the boron of boronate groups (e.g., boronate pinacol ester groups), followed by reaction with a hydroxy-containing crosslinker, such as diglycerol, D-sorbitol, ethylene glycol, diethylene glycol, triethylene glycol, or a polyethylene glycol. In some embodiments, the hydroxy-containing crosslinker is a polyol crosslinking molecule, as further discussed below. Since crosslinking of the boronate groups with the filler is also desired, less than the total number of boronate groups on the polymer should be engaged in crosslinking. Alternatively, the polymer may be crosslinked between functional groups other than boronate groups. For example, the polymer may be functionalized with amine (NH₂) groups, which may be crosslinked by any of the amine-reactive crosslinkers known in the art (e.g., a dicarboxy, dialdehyde, or dialkylhalide crosslinker). In some embodiments, a crosslinker other than a polyol crosslinking molecule is excluded from the composite.

The filler (component (ii)) is a solid material embedded within the polymer to enhance the strength, toughness, and other physical properties of the polymer. In some embodiments, the filler is composed of discrete particles, while in other embodiments, the filler is composed of a network of particles (typically fibers) connected with each other, such as a woven or non-woven mesh or fabric. The filler can have essentially any composition, including inorganic and organic compositions, provided that the solid particles remain solid at an elevated temperature of at least 100° C., 200° C., or higher and are preferably not soluble in water or the polymer. In order to crosslink with the polymer, the solid particles should possess surface hydroxy functional groups that can react with boronate ester groups. The filler may naturally contain surface hydroxy groups, such as in glass or other metal oxide fillers, or the filler may be subjected to a process which functionalizes its surface with hydroxy groups. The hydroxy groups may be directly bound to the surface of the filler (as in glass, metal oxide, or ceramic) or the hydroxy groups may be indirectly bound to the surface of the filler by the presence of hydroxy-containing organic molecules bound to the surface of the filler. The particles in the filler may have any shape, including fiber, plate, rod, and polyhedral shapes. In particular embodiments, the filler is composed of fibers, which may be discrete or in a network (woven or non-woven) form. The term “fiber,” as used herein, generally refers to a particle having a length-to-width aspect ratio of at least or greater than 100, and more typically at least or greater than 1000.

In one set of embodiments, the filler has a carbon composition. The carbon filler is typically in the form of particles, typically fibers, wherein the carbon fibers may be woven or non-woven, as well known in the art. The carbon filler can be composed of any of the carbon particles known in the art that are composed at least partly or completely of elemental carbon, and may be conductive, semiconductive, or non-conductive. The carbon particles may be nanoparticles (e.g., at least 1, 2, 5, or 10 nm, and up to 20, 50, 100, 200, or 500 nm in at least one or two dimensions), microparticles (e.g., at least 1, 2, 5, or 10 μm, and up to 20, 50, 100, 200, or 500 μm in at least one or two dimensions), or macroparticles (e.g., above 500 μm, or at least or up to 1, 2, 5, 10, 20, 50, or 100 mm in at least one or two dimensions). Some examples of carbon particles include carbon black (“CB”), carbon onion (“CO”), a spherical fullerene (e.g., buckminsterfullerene, i.e., C₆₀, as well as any of the smaller or larger buckyballs, such as C₂₀ or C₇₀), a tubular fullerene (e.g., single-walled, double-walled, or multi-walled carbon nanotubes), carbon nanodiamonds, carbon nanohorns, and carbon nanobuds, all of which have compositions and physical and electrical properties well-known in the art. As known in the art, fully graphitized carbon nanodiamonds can be considered to be carbon onions.

In some embodiments, the carbon particles (or fibers) are made exclusively of carbon, while in other embodiments the carbon particles can include an amount of one or a combination of non-carbon non-hydrogen (i.e., hetero-dopant) elements, such as nitrogen, oxygen, sulfur, boron, silicon, phosphorus, or a metal, such as an alkali metal (e.g., lithium), alkaline earth metal, transition metal, main group metal (e.g., Al, Ga, or In), or rare earth metal. Some examples of binary carbon compositions include silicon carbide (SiC) and tungsten carbide (WC). The amount of hetero element can be a minor amount (e.g., up to 0.1, 0.5, 1, 2, or 5 wt % or mol %) or a more substantial amount (e.g., about, at least, or up to 10, 15, 20, 25, 30, 40, or 50 wt % or mol %). In some embodiments, any one or more of the specifically recited classes or specific types of carbon particles or any one or more of the specifically recited classes or specific types of hetero-dopant elements are excluded from the carbon particles.

In some embodiments, the carbon particles are nanoscopic, microscopic, or macroscopic segments of any of the high strength continuous carbon fiber compositions known in the art. Some examples of carbon fiber compositions include those produced by the pyrolysis of polyacrylonitrile (PAN), viscose, rayon, pitch, lignin, or a polyolefin, any of which may or may not be heteroatom-doped, such as with nitrogen, boron, oxygen, sulfur, or phosphorus. The carbon fiber may alternatively be vapor grown carbon nanofibers. The carbon particles may also be two-dimensional carbon materials, such as graphene, graphene oxide, or graphene nanoribbons, which may be derived from, for example, natural graphite, carbon fibers, carbon nanofibers, single walled carbon nanotubes and multi-walled carbon nanotubes. The carbon fibers, which may be single filaments or bundled, typically have a thickness of at least 1, 2, 5, 10, 20, or 50 microns. The carbon fiber typically possesses a high tensile strength, such as at least 500, 1000, 2000, 3000, 5000, 7,000, or 10,000 MPa, or higher, with a degree of stiffness generally of the order of steel or higher (e.g., 100-1000 GPa). In some embodiments, any one or more classes or specific types of the foregoing carbon particles are excluded from the composition.

Typically, carbon particles in their pristine or unsized state contain few if any surface hydroxy groups. Methods of functionalizing carbon particles with surface hydroxy groups are well known in the art. Hydroxy groups may be formed directly on the carbon surface by, for example, subjecting the carbon filler to an oxygen plasma process. Hydroxy groups may be indirectly placed on the carbon surface by, for example, bonding a hydroxy-containing molecular or polymeric sizing agent onto the carbon filler by means well known in the art. In particular embodiments, the carbon filler is bonded to a polyol (e.g., diol, triol, tetrol, or higher polyol) molecule or polymer. Some examples of diol molecules include ethylene glycol, propylene glycol, diethylene glycol, triethylene glycol, tetraethylene glycol, and the polyalkylene glycols. Some examples of triol molecules include glycerol, benzene-1,3,5-triol, and 3-methylpentane-1,2,5-triol. Some examples of tetrol molecules include butane-1,2,3,4-tetrol (or erythritol) and diglycerol. The hydroxy-containing molecule may contain a higher number of hydroxy groups, such as six hydroxy groups, such as in sorbitol, mannitol, and cyclohexane-1,2,3,4,5,6-hexol. The hydroxy-containing molecule may, in some embodiments, be selected from any of the polyol crosslinking molecules discussed in further detail below. The hydroxy-containing molecule may alternatively be a hydroxy-containing organosilane molecule, wherein the silicon atom in the organosilane molecule is bound to the surface of the carbon filler with the hydroxy groups of the organosilane molecule available to engage in dynamic crosslinking with the boronate groups on the polymer. The hydroxy-containing molecule may, in some embodiments, include an amino group or linker.

In another set of embodiments, the filler has a metal oxide or metal sulfide composition. As well known, particles having a metal oxide or metal sulfide composition typically possess surface hydroxy or thiol groups, which, for purposes of the present invention, are able to engage in dynamic crosslinking with the boronate groups on the polymer. The term “metal”, as used herein, can refer to any element selected from main group, alkali, alkaline earth, transition metal, and lanthanide elements. Thus, the metal oxide or metal sulfide may be a main group metal oxide or sulfide, alkali metal oxide or sulfide, alkaline earth metal oxide or sulfide, transition metal oxide or sulfide, or lanthanide metal oxide or sulfide. Some examples of main group metal oxide compositions include SiO₂ (i.e., silica, e.g., glass or ceramic), basalt, B₂O₃, Al₂O₃ (alumina), Ga₂O₃, SnO, SnO₂, PbO, PbO₂, Sb₂O₃, Sb₂O₅, and Bi₂O₃. Some examples of alkali metal oxides include Li₂O, Na₂O, K₂O, and Rb₂O. Some examples of alkaline earth metal oxide compositions include BeO, MgO, CaO, and SrO. Some examples of transition metal oxide compositions include Sc₂O₃, TiO₂ (titania), Cr₂O₃, Fe₂O₃, Fe₃O₄, FeO, CO₂O₃, Ni₂O₃, CuO, Cu₂O, ZnO, Y₂O₃ (yttria), ZrO₂ (zirconia), NbO₂, Nb₂O₅, RuO₂, PdO, Ag₂O, CdO, HfO₂, Ta₂O₅, WO₂, and PtO₂. Some examples of lanthanide metal oxide compositions include La₂O₃, Ce₂O₃, and CeO₂. In some embodiments, mixed metal oxides (mixed composition of any of the above-mentioned metal oxides) are used. In some embodiments, any one or more classes or specific types of the foregoing metal oxides (or all metal oxides) are excluded from the composite. Analogous metal sulfide compositions can be derived by substitution of oxide (O) with sulfide (S) in any of the exemplary metal oxide compositions recited above (e.g., SiS₂, Li₂S, or CaS). In some embodiments, any one or more of the above described metal oxide or metal sulfide compositions are excluded.

In another set of embodiments, the filler has a polymeric composition. The polymeric composition may be a natural or synthetic (artificial) polymeric composition. Some examples of natural polymers (biopolymers) include cellulose (e.g., cellulose fiber), hemicellulose, chitin, and chitosan. Some examples of synthetic polymers include polyvinylalcohol (PVA), polyvinylacetate, polyvinypyrrolidinone, polyacrylamide, polyethylene (PE), polypropylene (PP), polystyrene (PS), polysiloxanes, polyamides, polyesters (e.g., PLA and/or PGA), and copolymers thereof. The polymeric filler may, in some embodiments, be in the form of fibers, which may be woven or unwoven. In some embodiments, any one or more of the above described polymeric filler compositions are excluded.

The filler particles can have any suitable size, typically up to or less than 100 microns. In different embodiments, the filler particles have an average size or substantially uniform size of precisely or about, for example, 0.001, 0.005, 0.01, 0.05, 0.1, 0.2, 0.3, 0.4 0.5, 0.6, 0.7, 0.8, 1, 2, 5, 10, 20, 50, or 100 microns, or an average size or substantially uniform size within a range bounded by any two of the foregoing values, e.g., 0.001-100 microns (wherein 0.001 microns=1 nm), 0.01-100 microns, 0.01-10 microns, 1-100 nm, or 1-100 microns, wherein the term “about” generally indicates no more than ±10%, ±5%, or ±1% from an indicated value. In some embodiments, at least 80%, 85%, 90%, 95%, 98%, or 99% of the particles have a size within any range bounded by any two of the exemplary values provided above. For example, at least 90% of the particles may have a size within a range of 0.005-10 microns, 0.01-10 microns, 0.1-10 microns, 0.005-1 microns, 0.01-1 microns, 0.1-1 microns, 0.005-0.1 microns, 0.005-0.05 microns, or at least or more than 95% of the particles may have a size within a range of 0.1-20 microns, 0.005-10 microns, 0.005-0.1 microns, 0.005-0.05 microns, 0.01-10 microns, 0.1-5 microns, 0.1-1 microns, 1-100 microns, or 1-100 nm. In some embodiments, 100% of the particles have a size within any of the size ranges above. For particles in which the three dimensions are not the same (e.g., plate or fiber), the particle size may refer to the longest dimension.

The filler is typically present in an amount of at least 0.1 wt % of the composite material. In different embodiments, the filler is present in an amount of precisely or about, for example, 0.1, 0.2, 0.5, 1, 2, 3, 4, 5, 10, 15, 20, 25, 30, or 40 wt %, or an amount within a range bounded by any two of the foregoing values (e.g., 0.1-40 wt %, 0.1-30 wt %, 0.1-20 wt %, 0.1-10 wt %, 0.1-5 wt %, 1-40 wt %, 1-30 wt %, 1-20 wt %, 1-10 wt %, or 1-5 wt %). Any of the filler compositions described above, which may have any of the carbon, metal oxide, or polymeric compositions described above, may be present in the composite material in any of the amounts provided above, or sub-ranges therein, and may, in addition, have any of the particle shapes and sizes or sub-ranges thereof, as also described above.

As noted earlier above, the composite material may (optionally) include polyol crosslinking molecules, which corresponds to component (iii). In some embodiments, polyol crosslinking molecules containing at least or greater than three, four, five, or six hydroxy groups per polyol crosslinking molecule are included in the polymer composite, wherein the hydroxy groups in the polyol crosslinking molecules engage in dynamic crosslinking with the boronic acid or boronic ester groups on the polymer, which is in addition to hydroxy groups on surfaces of the solid filler engaging in dynamic crosslinking with the boronic acid or ester groups on the polymer. The polyol crosslinking molecules may be present in an amount of precisely or about, for example, 1, 2, 5, 10, 20, 30, 40, 50, 60, 70, or 80 mol % of boronic acid or boronic ester groups, or the polyol crosslinking molecules may be present in an amount within a range bounded by any two of the foregoing values. In different embodiments, the polyol crosslinking molecules may be present in an amount within a range of, for example, 1-80 mol %, 1-50 mol %, 1-20 mol %, 1-10 mol %, 1-5 mol %, 5-80 mol %, 5-60 mol %, 5-50 mol %, 5-20 mol %, 5-10 mol %, 10-80 mol %, 10-60 mol %, 10-50 mol %, 10-20 mol %, 20-80 mol %, 30-80 mol %, 40-80 mol %, 20-60 mol %, 30-60 mol %, 20-50 mol %, or 20-40 mol % of boronic acid or boronic ester groups. In separate or further embodiments, the polyol crosslinking molecules have a molecular weight of up to, no more than, or less than 5000 g/mol, 4000 g/mol, 3000 g/mol, 2000 g/mol, or 1500 g/mol. In other embodiments, the polyol crosslinking molecules have a molecular weight of at least or above 1500 g/mol, 2000 g/mol, 3000 g/mol, 4000 g/mol, 5000 g/mol, 10,000 g/mol, 20,000 g/mol, or 50,000 g/mol.

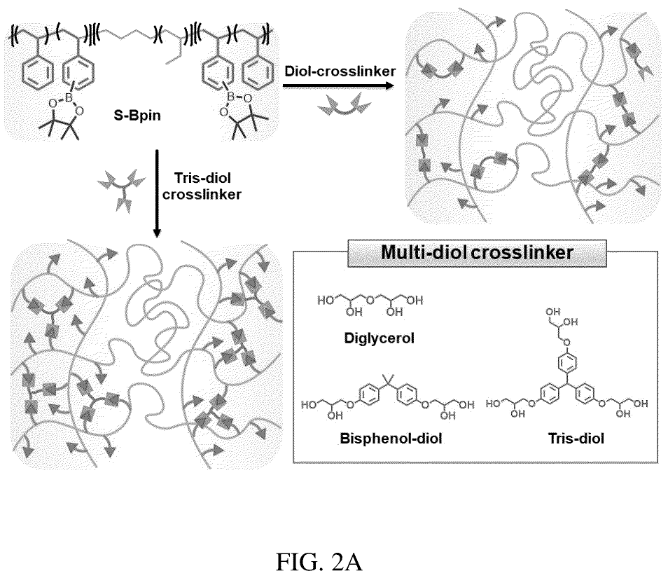

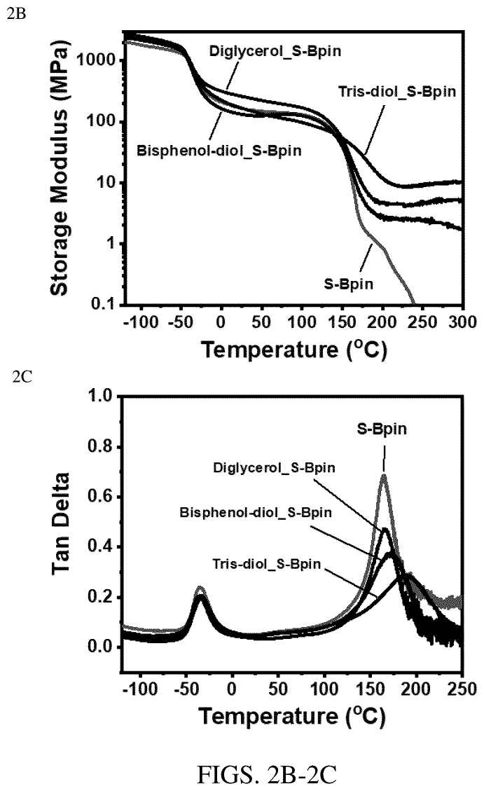

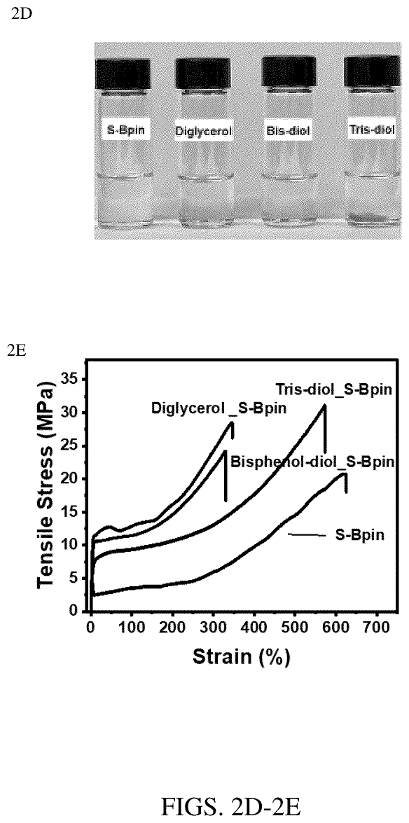

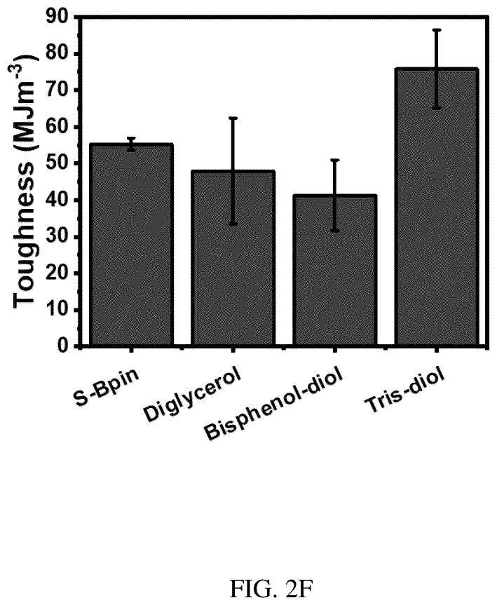

Some examples of crosslinking molecules containing three hydroxy groups (i.e., triols) include glycerol, trimethylolpropane, benzene-1,3,5-triol, 3-methylpentane-1,2,5-triol, 4,4′,4″-trihydroxytriphenylmethane, tris(4-hydroxyphenyl)ethane, triethanolamine, and tris(4-hydroxyphenyl)amine. Some examples of crosslinking molecules containing four hydroxy groups (i.e., tetrols) include bisphenol A-bis(2,3-dihydroxypropyl)ether (i.e., “bisphenol-diol,” as shown in FIG. 2A), butane-1,2,3,4-tetrol (or erythritol), diglycerol (as shown in FIG. 2A), pentane-1,2,4,5-tetrol, and [1,1′-biphenyl]-3,3′4,4′-tetrol. An example of a molecule containing five hydroxy groups (i.e., a pentol) is xylitol. Some examples of molecules containing six hydroxy groups (i.e., hexols) include 4,4′,4″-tris(2,3-dihydroxypropylether)-triphenylmethane (i.e., “tris-diol,” as shown in FIG. 2A), 3,3′,3″,4,4′,4″-hexahydroxy-triphenylmethane, sorbitol, mannitol, hexane-1,2,3,4,5,6-hexol, cyclohexane-1,2,3,4,5,6-hexol, propane-1,1,2,2,3,3-hexol, propane-1,2,2,3,3,3-hexol, and [1,1′-biphenyl]-2,2′,4,4′,5,5′-hexol. Some examples of polyol crosslinking molecules containing more than six hydroxy groups include tannic acid, novolak resins, resole resins, hydroxylated polystyrene, poly (4-hydroxystyrene), tris aminohexadiol (TAHD) (structure shown later below), and polyvinylalcohols, wherein a polyol polymer may have a M_{w} of, for example, 5,000, 10,000, 20,000, 30,000, 40,000, 50,000, 100,000, or 150,000 g/mol, or a M_{w} within a range bounded by any two of the foregoing values. Typically, the crosslinking molecule is uncharged (neutral). However, in some embodiments, the crosslinking molecule may be positively or negatively charged. In some embodiments, any one or more of the above described specific or general types of crosslinking molecules is excluded from the composite. Moreover, any of the above types of crosslinking molecules can be combined with any of the polymers and fillers described earlier above to produce a composite material.

In another aspect, the present disclosure is directed to a method of producing the composite material described above. In some embodiments, a boronated polymer is produced by reaction of a precursor polymer (e.g., SEBS) with bis (pinacolato) diboron (B₂Pin₂) by known methods and as further described in the Examples section. In other embodiments, a boronated polymer is produced by polymerization of a boronate-containing monomer, such as 4-vinylphenylboronic acid or 4-vinylphenylboronic acid pinacol ester. To produce the composite, in a typical process, the boronated polymer is dissolved in solution, and the polymer solution is mixed with a solution containing the crosslinking molecules. The mixture of the boronated polymer and crosslinking molecules is combined with the hydroxy-containing filler (e.g., woven or non-woven carbon fibers, glass fibers, or basalt fibers), and the resulting final mixture is removed of solvent by heating at an appropriate temperature (generally up to or less than 150, 120, or 100° C., or within a range therein). In some embodiments, the dried composite material is cured, such as by hot pressing at an elevated temperature (e.g., 150, 180, 200, 220, or 250° C., or within a range therein) over a suitable period of time (e.g., 20, 30, 45, or 60 minutes).

Examples have been set forth below for the purpose of illustration and to describe certain specific embodiments of the invention. However, the scope of this invention is not to be in any way limited by the examples set forth herein.

### EXAMPLES

### Overview

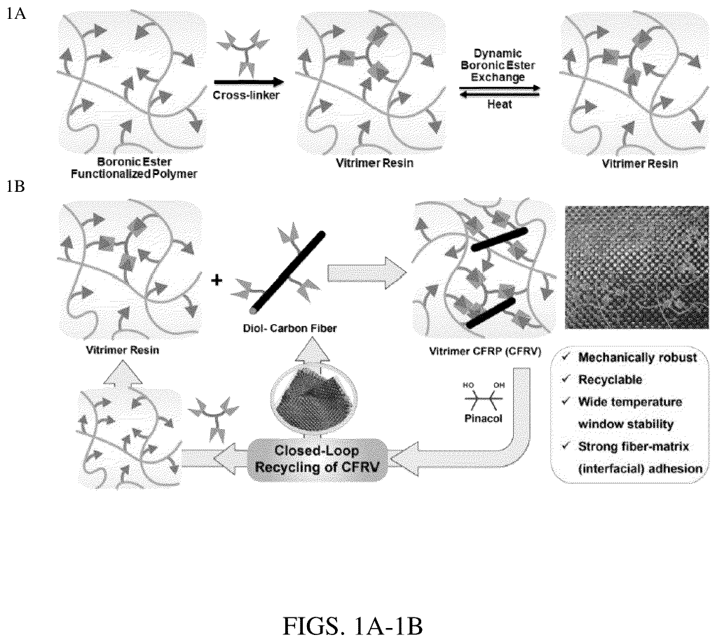

The following experiments utilized a boronic ester functionalized triblock commodity thermoplastic elastomer, polystyrene-b-poly(ethylene-co-butylene)-b-polystyrene (SEBS), and a multi-diol crosslinker to prepare a vitrimer resin. An exemplary process for producing the vitrimer resin is shown schematically in FIG. 1A. To master the interfacial interaction between carbon fibers (CFs) and polymer matrices, CFs were surface functionalized using dynamic diol functional groups which can form dynamic covalent bonds with the boronic ester group of polymer matrices. The surface modification was characterized by XPS, TGA, and SEM. The prepared carbon fiber-reinforced polymer (CFRP) composites showed remarkably enhanced interfacial adhesion and toughness, as observed in the tensile properties, interlaminar shear strength, and Raman mapping. Significantly, the reversible crosslinked nature of the boronic ester exchange reaction not only permits thermal reprocessing but also provides the opportunity for closed-loop recycling of CFs and polymer matrices, as schematically shown in FIG. 1B. The resulting composites possess an improved CF-polymer interface by virtue of the dynamic crosslinking with boronate groups. The enhanced fiber-matrix interfacial adhesion provides exceptionally tough and closed-loop recyclable CFRPs that may be used in many lightweight material applications, including automotive, aerospace, wind turbine blade, and construction industries.

More specifically, SEBS was modified with boronic ester groups and was dynamically crosslinked by multiple diol crosslinkers to generate tough vitrimer resins. The vitrimer that was crosslinked with the tris-diol crosslinking molecule, as schematically shown in FIG. 2A, showed significantly enhanced mechanical robustness, wide temperature window stability, recyclability, and excellent solvent resistance properties. The vitrimer resin was further reinforced by diol-functionalized carbon fiber to prepare remarkably strong and closed-loop recyclable carbon fiber-reinforced vitrimer (CFRV) composites. The dynamic covalent bonding in vitrimer resin and fiber interface results in tough mechanical properties, strong fiber-matrix interfacial adhesion, and efficient closed loop-recycling of both fiber and resin.

The interface between the fiber and matrix was measured by Raman mapping, which indicates strong interfacial interaction between the diol-functionalized carbon fiber and vitrimer matrix. For example, the CFRV containing diol-CF exhibited 38% higher interfacial adhesion than that of pristine CF containing CFRP. Moreover, the vitrimer composites with diol-functionalized carbon fiber exhibited ˜731 MPa tensile strength, which is 26% and 49% higher than those of the unmodified CFRV composites and conventional epoxy CFRP composites, respectively, which demonstrates the greater reinforcement effect of fiber modification. In addition, the interfacial shear strength of the functionalized CF composites was increased 45% compared to the pristine CF composite. Significantly, the CFRV composites can undergo closed-loop recyclability and the recovered CF can maintain their mechanical integrity over multiple cycles without deteriorating the mechanical performance. The dynamic boronic ester exchange also advantageously permit repairability, fast thermoformability, and self-adhesion of the CFRV composite when hot-pressed at 200° C. for 10 minutes. This study demonstrates that the incorporation of dynamic covalent bonds onto the CF surface is critical not only to improve the interfacial adhesion but also to improve the recyclability of both the resin and the fiber of composites.

### Materials

Polystyrene-b-poly(ethylene-co-butylene)-b-polystyrene (SEBS) (Mn=118 kg/mol with D=1.08; 30 mol % polystyrene repeating unit; 30 wt % polystyrene), 4,4′-di-tert-butyl bipyridine (dtbpy) and chloro(1,5-cyclooctadiene)iridium (I) dimer ([IrCl(COD)]₂) were obtained from a commercial source. Bis(pinacolato)diboron (B₂Pin₂) was obtained from a commercial source. The woven carbon fiber fabric, anhydrous tetrahydrofuran (THF), ACS grade methanol, dichloromethane (DCM), chloroform (CHCl₃), dimethylformamide (DMF), and ethyl acetate were all obtained from a commercial source. All chemicals were used as received unless otherwise noted.

### Characterization Methods

All ¹H NMR spectra were recorded on a spectrometer operating at 400 MHz. Thermogravimetric analysis (TGA) data were recorded on a TGA instrument over the range of 20 to 800° C., with a heating rate of 10° C. min⁻¹ under a flow of N₂ (40 mL min⁻¹). Fourier transform infrared spectra were obtained using an FTIR instrument operating over the range of 400-4000 cm⁻¹ at ambient temperature using an ATR attachment.

Tensile Analysis. Tensile stress and strain of resin samples were measured using a universal testing system equipped with 1 KN sensor following the ASTM D1708 standard. A dog-bone tensile test piece die-cutting punch press was used to cut the dog-bone shape films with a width of 2.5 mm, a length of 7 mm, and an average thickness of 0.3 mm, which were tested at room temperature. The actual thicknesses, widths and lengths were individually measured at several areas of each sample using a caliper. Samples were elongated at the rate of 1 mm s⁻¹ until break. Toughness was calculated from the area under the stress-strain curve. Young's modulus was measured at 1% strain of the stress-strain curve. The mechanical properties data reported are an average of at least three specimens tested.

Dynamic Mechanical Analysis (DMA). Dynamic mechanical properties were conducted using a DMA analyzing device with a tension clamp. After hot-pressing at 200° C., the films were cut into rectangular shapes. Each sample was tested in a temperature range from −120° C. to 300° C. at a rate of 3° C. min⁻¹ with a frequency of 1 Hz and 15 μm amplitude. From the DMA plots of multidiol_S-Bpin samples, the crosslinked density of multi-diol_S-Bpin was determined using the rubber elasticity equation; E=3RTv, where v is the crosslinked density, Er is the storage modulus, T is temperature relating to E selected as 40° C. above the T_{g} and R is the universal gas constant (8.314 J⁻¹ K⁻¹ mol⁻¹).

Rheology Measurements. Rheological measurement was conducted using a commercial rheometer using 8 mm plates with a parallel plate geometry. For stress relaxation experiments, the samples were tested in a temperature range from 200° C. to 270° C. by applying a constant strain at 2% with 20 min relaxation time. Before each measurement, the sample underwent thermal stabilization for 5 minutes to ensure that thermal equilibrium was reached. The relaxation modulus was monitored over time.

### Synthesis of S-Bpin

The following experiments employed microphase-separated SEBS triblock commodity polymer, where the soft block participates to dissipate energy and the hard styrene block is modified to interact with sized carbon fiber and dynamic crosslinker for achieving high strength and toughness. The borylated SEBS triblock copolymer (S-Bpin) was synthesized from 30-mole percent (mol %) styrene containing commodity thermoplastic elastomer SEBS (118,000 g/mol) via aromatic C—H borylation reaction following our recently reported method (M. A. Rahman et al., Science Advances 7(42), eabk2451) with slight changes. ¹H NMR and Fourier Transform Infrared (FTIR) spectra of SEBS and the synthesized S-Bpin confirmed formation of the product.

More specifically, SEBS (5.00 g, 14.2 mmol of styrene units), B₂Pin₂ (12.7 g, 49.8 mmol, 3.5 equiv), [IrCl(COD)]₂ (0.502 g, 1.5 mol % based on the amount of B₂Pin₂), dtbpy (0.401 g, 3 mol % based on the amount of B₂Pin₂), anhydrous THF (50 ml), and a magnetic stirring bar were placed in a 100 ml flame-dried round-bottom flask and purged with argon for 30 min. The reaction flask was sealed under an argon atmosphere and placed in the preheated oil bath at 75° C. The reaction was stopped after 24 h and cooled to room temperature. The solution was diluted with chloroform (50 ml) and precipitated into methanol followed by several washes with methanol. The resulting white color polymer was collected by suction filtration and dried under vacuum at room temperature. The dissolution and precipitation methods were repeated two more times for the complete removal of catalysts and other unreacted small molecules. The degree of functionalization of styrene units was calculated from ¹H NMR, based on the relative intensity of the methyl group in the 1,2-butylene unit of the polymer main chain (at 0.84 ppm) with respect to the increased integral ratio of the overlapping SEBS-methylene and boronated ester methyl resonance (at 0.9 to 1.5 ppm).

### Synthesis of Tris Diol Crosslinker

A mixture of 1,1,1-tris-(p-hydroxyphenyl) ethane glycidyl ether (10 g, 32.6 mmol) was dissolved in 25 mL of dimethyl sulfoxide followed by addition of 8 mL of 1M sulfuric acid and 10 mL of distilled water. The solution was stirred overnight at room temperature. After the reaction time, the mixture was washed well with ethyl acetate and precipitated in water. The resulting sticky red precipitate was collected by decanting the solvent and vacuum drying overnight.

### Vitrimer Synthesis Using S-Bpin Polymers with Multidiol (Polyol) Crosslinkers

The vitrimer resin with dynamic boronic ester was synthesized from S-Bpin and a dynamic multi-diol crosslinker, as schematically shown in FIG. 2A. The hydroxyl groups in the multi-diol crosslinkers react with boronic ester groups on S-Bpin to produce dynamic boronic ester-based vitrimers. The different architectures of the crosslinkers can provide mechanical variability on the vitrimer properties. Three different multi-diol crosslinkers, including diglycerol, bisphenol A diol, and tris-diol (3,3′,3″-((methanetriyltris (benzene-4,1-diyl))tris(oxy))tris(propane-1,2-diol)), were selected to prepare the dynamic crosslinked vitrimer. The resulting vitrimers are denoted as diglycerol_S-Bpin, bisphenol-diol_S-Bpin, and tris-diol_S-Bpin, respectively.

The tris-diol crosslinker was synthesized from tri-epoxy-based starting materials. The synthesis of the tris-diol crosslinker was confirmed by observing a newly emerged broad peak at 3400-3450 cm⁻¹ corresponding to an OH group in the FTIR spectrum. The multi-diol with two and three arms was selected to investigate the consequence of diol spacer length, flexibility, network density, and mechanical properties of vitrimer. The tetrahydrofuran (THF) solution of S-Bpin and 5 mol % of multi-diol crosslinker (i.e., 5 mol % of boronic ester group in S-Bpin) were mixed at room temperature and dried under reduced pressure at 120° C. to obtain partially crosslinked networks, and they were hot pressed at 200° C. for 1 h under ˜1 t pressure to result in fully cured resin films. The crosslinking reaction between hydroxyl groups on multi-diol and boron pinacol ester groups of S-Bpin was confirmed by the FTIR spectrum, where a broad signal appeared at 1114 cm⁻¹ corresponding to the B—O bond while the signal at 3500 cm⁻¹ for the OH group of the crosslinker disappeared.

More specifically: S-Bpin 1.00 g was first dissolved in 10 mL of THF. Tris-diol 0.070 g (5 mol % equivalent of grafted boronic esters) was also dissolved in 1 mL of DMF. The two solutions were mixed and let it to stir for 3-4 minutes at room temperature. The mixture was vacuum-dried at 120° C. overnight and later hot-pressed at 200° C. for 30 minutes.

### Synthesis of Functionalized Diol

2-(ethoxydimethylsilylethan-1-amine (2.00 g, 12.4 mmol) and glycidol (0.918 g, 12.4 mmol) were reacted at room temperature overnight. The resulting solution was used to functionalize the carbon fibers.

### Carbon Fiber Functionalization

Prior to use, the plain woven carbon fiber fabric was unsized by soaking in acetone at room temperature for 24 h and vacuum drying overnight. The dried carbon fiber fabric was then placed in a pressure tube and reacted with 0.5 mL of the synthesized diol using THF as the solvent. The reaction was continued for 2 days at 70° C. After the reaction time, the functionalized fiber fabric was vacuum-dried at 120° C. to remove the solvent.

### Preparation of Carbon Fiber Composites

The composite was prepared with 30% polymer loading and 70% fiber weight. Synthesized S-Bpin (3.41 g) was fully dissolved in 30 mL of THF and mixed with tris-diol crosslinker (0.238 g, 5% mol based on the amount of boronic acid functionalization determined by the 1H NMR quantification), dissolved in 1 mL of dimethyl formamide. The solution was mixed for about 1 minute and poured into three layers of plain weave carbon fiber cloth (8.50 g) with dimensions of 6 inches×3.5 inches. The polymer solution was evenly dispersed among the three layers. The dried carbon fiber composite was obtained after removing the solvent in a vacuum oven at 120° C. overnight. The dried composite was cured by hot pressing at 200° C. for 45 minutes.

### Chemical Recycling of CF Composite and S-Bpin

An excess of pinacol 5.00 g was dissolved in THF. The CF composite (6 inches×3.5 inches) was soaked in the THF solution at 60° C. overnight, in a sealed beaker, with continuous stirring. After the reaction time, the three layers of carbon fiber were carefully removed and rinsed with THF, followed by methanol. The THF and methanol solution, which was used to rinse the CF, was collected and combined with the recycled solution to ensure that all pinacol and S-Bpin crosslinked polymers were retrieved. The carbon fibers were recovered from their original woven state and used to fabricate recycled composite samples. The weight of the retrieved carbon fiber was very close to that of the original carbon fiber. The solution was precipitated into methanol to collect the S-Bpin polymer. The white color solid was collected by suction filtration followed by three washes with methanol to dissolve all the residual pinacol. After precipitating pinacol, the solution was concentrated by rotary evaporation to collect the tris diol crosslinker. The tris-diol crosslinker was purified and isolated by recrystallizing it twice with water.

### Chemical Recycling of the Resin

Crosslinked S-Bpin resin and excess pinacol were dissolved in THF overnight at room temperature. After being precipitated into methanol, the S-Bpin polymer was collected as a white solid. The weight of the retrieved polymer (90.1% as of the initial) is on par with that of the original weight of the polymer used in the resin. The recycled polymer was again mixed with the crosslinker and fabricated the recycled resin. The mechanical properties were tested up to three cycles. To collect the tris-diol crosslinker, the solution was concentrated by rotary evaporation and isolated by recrystallizing it twice with water.

### Thermomechanical Properties of the Multidiol_S-Bpin resins

The presence of the constant 2^{nd} rubbery plateau at high temperatures (above 160° C.) in Dynamic Mechanical Analysis (DMA) curves (FIG. 2B) further confirmed the formation of dynamic covalent crosslinking between the multi-diol crosslinker and S-Bpin polymer. The increased storage modulus at the 2^{nd} rubbery plateau region of tris-diol_S-Bpin clearly indicates a higher network stiffness and crosslinked density than the two-arm diol-crosslinked resin. For example, the crosslinked density decreased from 680.0 mol m⁻³ for tris-diol_S-Bpin to 370.6 mol m⁻³ and 202.2 mol m⁻³ for diglycerol_S-Bpin and bisphenol-diol_S-Bpin, respectively. The tan δ curve from DMA (FIG. 2C) indicates a significant shift in the glass transition temperature (Tg) of borylated polystyrene block from ˜165° C. in S-Bpin to ˜190° C. in tris-diol_S-Bpin. The Tg is closely dependent on both network stiffness and crosslinking density; thus, tris-diol_S-Bpin exhibited the highest Tg (190° C.) compared to diglycerol_S-Bpin (175° C.) and bisphenol-diol_S-Bpin (167° C.). In addition, the tan δ peak of tris-diol was also lower than that of diglycerol_S-Bpin and bisphenol-diol_S-Bpin, indicating that the network of tris-diol_S-Bpin was more rigid than that of diglycerol_S-Bpin and bisphenol-diol_S-Bpin. In contrast, diglycerol_S-Bpin exhibited higher Tg than that of bisphenol-diol_S-Bpin which is mainly due to the restricted motion of the smaller spacer length of diglycerol, while bisphenol-diol_S-Bpin has two benzene rings connected to methane, which can generate internal rotation and thus provide flexibility of the chain.

The crosslinking nature of multi-diol_S-Bpin was demonstrated via a solvent resistance study, where a universal solvent (THF) was selected for this system, as THF was used to make all S-Bpin-based resins. The multi-diol_S-Bpin films were submerged in THF for 24 hrs at room temperature, and the solubility was monitored. As illustrated by the photographs in FIG. 2D, S-Bpin, Diglycerol_S-Bpin, and Bisphenol_S-Bpin films were dissolved in THF, while tris-diol_S-Bpin remained intact even after 24 hrs soaking under THF. The excellent THF solvent resistance of tris-diol_S-Bpin, compared to the two other crosslinkers, is due to the higher crosslinking density.

The mechanical properties of multi-diol_S-Bpin resins exhibited significant improvement in stiffness, yield point, ultimate tensile strength as well as toughness compared to uncrosslinked S-Bpin, as observed in the uniaxial tensile stress-strain curves in FIG. 2E at room temperature. In contrast to uncrosslinked S-Bpin polymer, the tris-diol crosslinker resulted in a 48% and 40% increase in ultimate tensile strength and toughness, respectively. The tensile properties of the tris-diol_S-Bpin exhibited the highest ultimate tensile strength (31 MPa) compared to the other diol-crosslinked resins. The toughness of tris-diol_S-Bpin (76 MJm⁻³) is 58% higher than that of diglycerol_S-Bpin (48 MJ⁻³) and 85% higher than that of bisphenol-diol_S-Bpin, as shown by the bar graph in FIG. 2F. The tris-diol crosslinker contains three aromatic diol arms that offer extra mechanical reinforcement to the polymeric network. In comparison to the other two crosslinkers, the tris-diol crosslinker's additional diol group may permit the formation of more dynamic covalent bonds with boronic ester groups, ultimately leading to an increase in crosslink density and network density, which is also observed in the calculated crosslinked density.

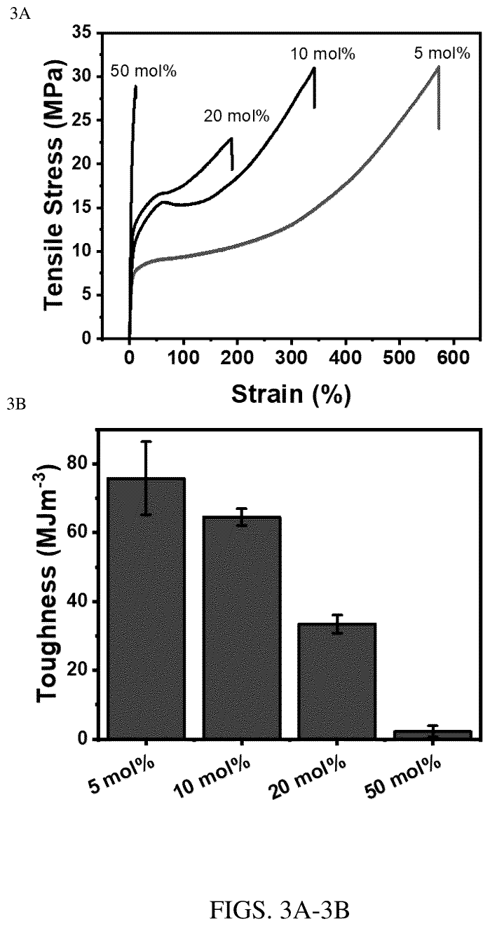

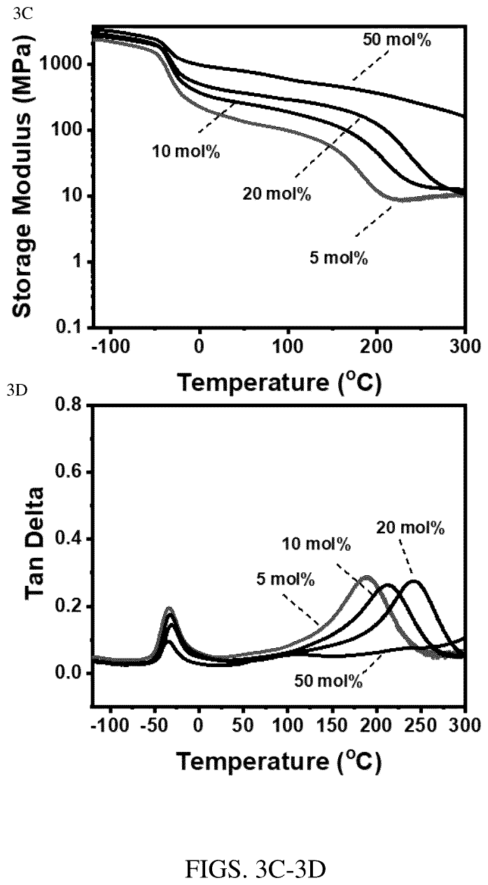

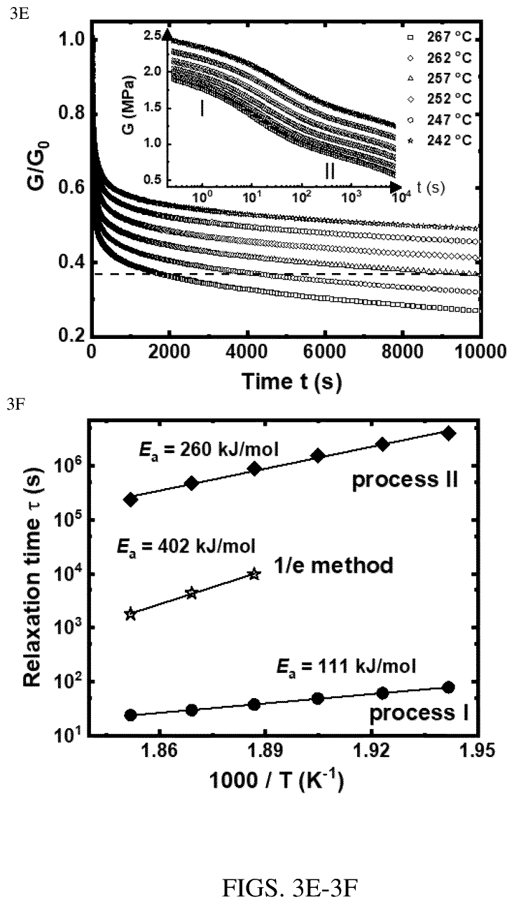

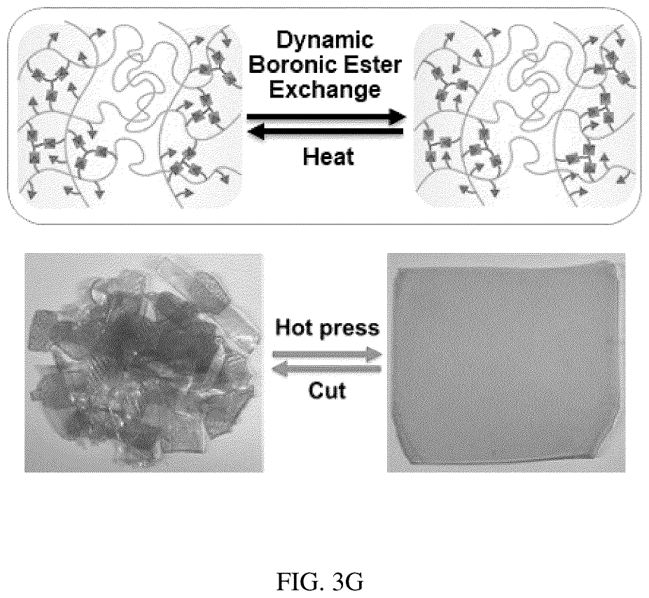

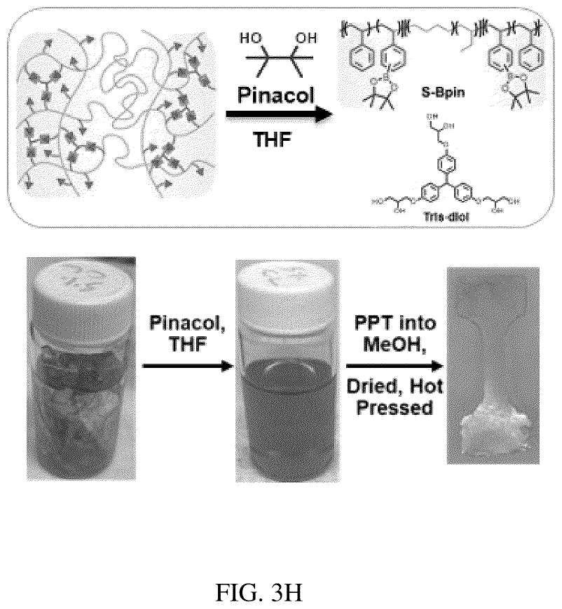

The tris-diol_S-Bpin was further analyzed due to its exceptional properties in thermal, mechanical, and solvent resistance. To attain superior thermomechanical properties with optimal crosslinked density, different percentages of tris-diol crosslinker was used depending on the number of moles of grafted boronic ester groups. As observed in the uniaxial tensile data in FIGS. 3A and 3B, there was a notable reduction in both tensile strain and toughness as the quantity of tris-diol crosslinker was increased, while the tensile strength remains almost identical. In the case of the 50 mol % tris-diol crosslinked S-Bpin, the degree of crosslinking is much higher, where many chemical bonds are connecting the polymer chains, which results in a rigid and brittle material that is prone to fracture under stress. On the other hand, the 5 mol % tris-diol_S-Bpin resin has a lower degree of crosslinking, which results in a more flexible, tough, and resilient material that can withstand greater deformation before fracturing. The increased toughness of the resin at this lower degree of crosslinking is due to the formation of a more interconnected, interpenetrating network structure. Furthermore, the DMA curves demonstrate a direct correlation between the amount of crosslinker and the crosslinked density of the resin, as evidenced by an increase in the rubbery plateau modulus, as shown in FIG. 3C, with increasing levels of crosslinker. The tan δ curve in FIG. 3D indicates a similar trend, revealing a noteworthy increase in the Tg with the increasing amount of crosslinker which can be attributed to the constrained chain mobility resulting from the increased crosslinking density. In fact, the Tg of the highly crosslinked 50 mol % tris-diol_S-Bpin was found to be beyond the selected temperature range (−120-300° C.). The storage modulus curves supported this finding by showing little to no slope at the second onset within the given temperature range. These results imply that less crosslinked resins are easier to process at lower temperatures than highly crosslinked resins. Therefore, further studies made use of a 5 mol % crosslinker percentage, as it provided the best thermomechanical properties.

The dynamic boronic ester crosslinked network is capable of undergoing dynamic boronic ester metathesis at an elevated temperature, wherein one oxygen atom of a boron ester acts as a nucleophile and attacks the boron of the second ester. The dynamic behavior of boronic ester and malleability of 5 mol % tris-diol_S-Bpin were demonstrated in a stress relaxation experiment, where stress decay is monitored at temperatures ranging from 250° C. to 300° C., with a constant strain of 2%. The data in FIG. 3E clearly indicates that as the temperature increases, the rate of stress relaxation also accelerates. This phenomenon can be attributed to the thermally activated boronic ester exchange reaction that takes place at elevated temperatures. Following the convention to demonstrate vitrimer material behaviors, the characteristic relaxation times (t) of the 5 mol % tris-diol_S-Bpin were measured at 1/e (37%) of the normalized relaxation modulus based on a single Maxwell model from rheological stress-relaxation test and examined the Arrhenius' behavior (V. Zhang et al., Journal of the American Chemical Society 2022, 144 (49), 22358-22377). The linear correlation of 1n(τ) with 1000/T demonstrated the Arrhenius' behavior of 5 mol % tris-diol_S-Bpin vitrimer and the apparent activation energy (Eₐ) of 149.64 kJ/mol was calculated from the slope. The topological freezing temperature (Tᵥ) was derived to be 173° C., which indicates the dynamic exchange in the network should readily occur close to the measured Tg of this system. FIG. 3F is a fitting of the relaxation times to the Arrhenius relation (R²=0.99755), wherein the deduced apparent activation energy Ea is ˜149 kJ/mol. The apparent Eₐ of the system appears to be higher than those required for boronic ester exchange in network rearrangement previously reported (Y. Chen et al., ACS Applied Materials & Interfaces 2018, 10 (28), 24224-24231). The higher apparent Eₐ may be partly due to the presence of bulky pinacol-containing boronic ester-functionalized styrene units decreasing the overall backbone mobility, which increases the kinetic energy barrier for the dynamic exchange to occur. In addition, the high apparent Eₐ can be attributed to the boronic ester metathesis exchange mechanism. This mechanism involves one ester oxygen searching for another boron atom within the second ester due to the lack of free diol groups. These factors together can slow down the exchange kinetics and impede the rearrangement of the network topology (J. Huang et al., Macromolecules 2023, 56 (3), 1253-1262).

The malleability of tris-diol_S-Bpin vitrimer was investigated by compression molding for multiple times at 200° C. under certain pressure for 10 min where the dynamic boronic ester links can rearrange to obtain thermally reprocessed vitrimer, as shown in the schematics in FIG. 3G. The thermally reprocessed tris-diol_S-Bpin vitrimer exhibits almost identical mechanical properties even after the second cycle, as shown by the data in FIG. 3I. Significantly, as shown by the schematics in FIG. 3H, the tris-diol_S-Bpin crosslinked polymer can also be chemically recycled in a closed-loop fashion allowing both the polymer and crosslinker to be reused for the same or different purposes. When dissolved in pinacol THF solution, the crosslinked polymer was found to exchange bonds with the diol groups of pinacol, leaving the crosslinker and polymer in the THF solution. The S-Bpin polymer was then precipitated into methanol and recovered in a pure form, as confirmed by the recovered polymer ¹H NMR spectrum. The tris-diol crosslinker was collected via rotary evaporating THF and recrystallizing with water. The IR spectroscopy of the recovered crosslinker was found to be consistent with its initial form. The used pinacol was also dried and recovered in its pure form as confirmed by the ¹H NMR spectrum. Chemically recycled S-Bpin was employed to synthesize a tris-diol_S-Bpin vitrimer, and its thermal and mechanical properties were examined. The DMA analysis exhibits that the Tg of all thermally reprocessed and chemically recycled resins maintains the same value as the pristine tris-diol_S-Bpin vitrimer. Remarkably, the ultimate tensile strength and elongation of the recycled vitrimer remained stable, even within the limits of an experimental error (FIG. 3I), a stark contrast to many of reported vitrimer systems, which are typically limited in their building block reuse after the depolymerization. These findings highlight the potential of using tris-diol S-Bpin vitrimer as a sustainable, closed-loop recyclable, and effective building block material.

### Carbon Fiber Surface Modification and Characterization

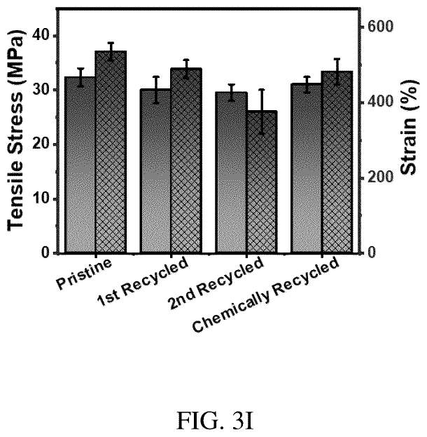

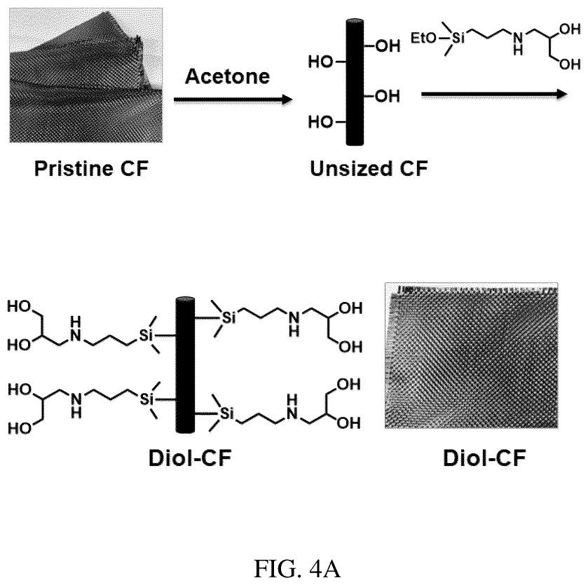

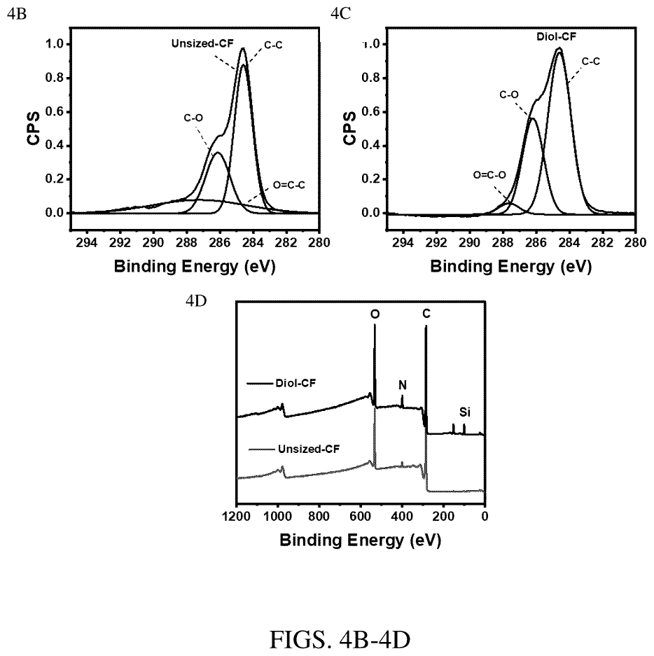

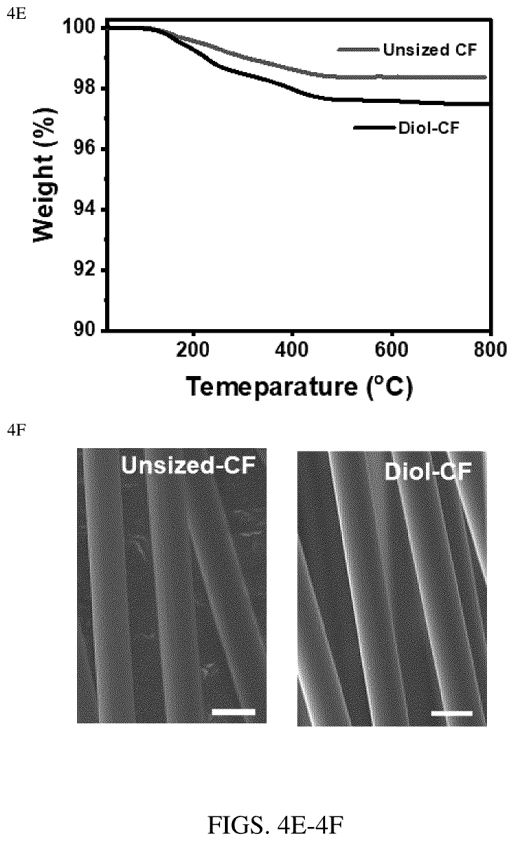

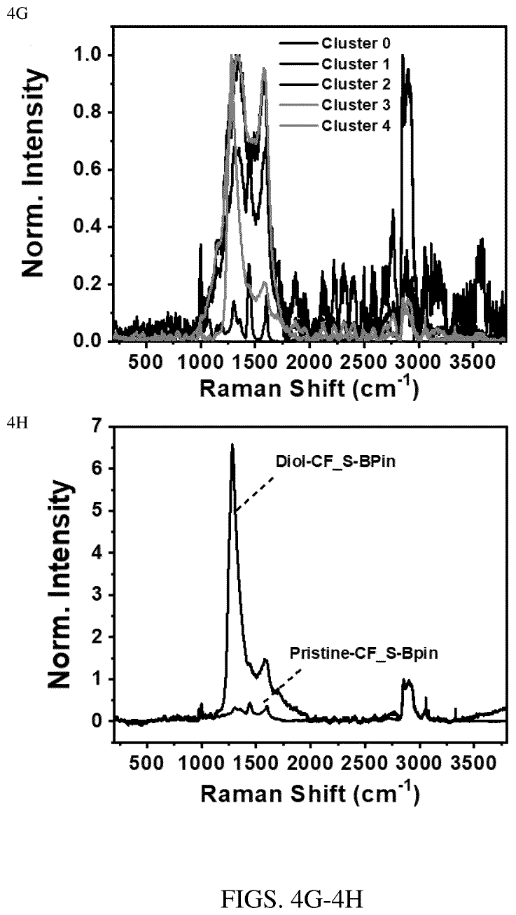

In an effort to mimic the superior binding ability of marine mussel proteins (where the dopamine dihydroxyl group plays a critical role) with the organic and inorganic surface using covalent and noncovalent interaction, CFs were functionalized with a diol group, as schematically shown in FIG. 4A. The diol-CF will interact with the vitrimer resin not only via covalent bonding but also via physical hydrogen bonding to increase the fiber-matrix interfacial adhesion.

First, IM7 grade woven CF was unsized with acetone to allow the fiber surface to increase the hydroxyl groups. Then, the diol functional group was incorporated on the CF surface via one-step reaction using a silane-diol reagent. The successful surface modification was evidenced by X-ray photoelectron spectroscopy (XPS) and thermogravimetric analysis (TGA). The XPS C 1s core-level spectra for unsized-CF and diol-CF exhibit three peak components at binding energies of approximately 284.6, 286.1, and 287.7 eV, which are attributed to the C—C, C—O, and O═C—O species, respectively, as shown in the XPS spectra in FIGS. 4B and 4C. The peak assigned to C—O in diol-CF shows a significantly higher intensity than that of untreated CF, indicating an increase in hydroxyl groups and greater polarity of the fiber surface. FIG. 4D indicates that the N signal peak intensity at 400.5 eV has increased and a new Si peak has emerged at around 103 eV for diol-CF, which strongly suggests the successful chemical modification of the fibers. Additionally, the increased intensity of the C and O peaks provides further evidence of diol functionalization.

The CF functionalization was further confirmed by the char yield percentage in TGA curves of unsized-CF and diol-CF, with results shown in the graph in FIG. 4E. The diol-CF exhibited around ˜1% more weight loss compared to the pristine-CF, which suggests that the CF surface was coated by the diol functional group. In addition, a conspicuous three-step degradation was observed for the diol-CF, wherein the additional decomposition events may resemble the sequential diol degradation bonded to the fiber surface. The morphology analysis of the fiber surface was performed by SEM analysis. The SEM image of the unsized-CF (FIG. 4F) shows some parallel longitudinal grooves, whereas the diol-CF surface (SEM image also in FIG. 4F) shows many smooth and shallow grooves, which confirms the uniform deposition of diols upon functionalization.

To assess the heterogeneity of the fiber-matrix interface and the interfacial interaction, Raman mapping was conducted with clustering analysis on unsized-CF_S-Bpin and diol-CF_S-Bpin composites. These composites were synthesized from S-Bpin with unsized-CF and diol-CF, respectively, without any crosslinker. FIGS. 4G and 4H show the Raman mapping spectra of unsized-CF_S-Bpin and diol-CF_S-Bpin composites respectively, which can be classified into five clusters (Clusters 0, 1, 2,3, and 4) color-coded with five different colors, as plotted in FIG. 4I. The red zone dominates both samples, with the centroid spectra exhibiting the S-Bpin chemistry. In both samples, a gray coded region was observed at the interface between the CF region and the S-Bpin region, which permitted a direct comparison of the interfacial chemistry between the two samples. FIG. 4J shows that the Diol-CF has a distinct peak centered at 1280 cm⁻¹ that is not present on the pristine-CF surface. This peak corresponds to the N—H bending mode stemming from the secondary amine groups on the CF surface. Furthermore, a closer look at the around 1000 cm⁻¹ and 3000-3500 cm⁻¹ indicates that the interface between sized CF and the S-Bpin shows a 1083 cm⁻¹ peak (C—N stretching) and 3085 and 3331 cm⁻¹ peaks (N—H stretching) that are absent in the unsized CF-S-Bpin sample. These findings indicate that the diol-CF has a strong covalent bond with the S-Bpin, which is a fundamental reason for the enhanced mechanical strength. Therefore, the Raman mapping results demonstrate strong interfacial interaction between the diol-functionalized carbon fiber and vitrimer matrix. By assessing the interface between the fiber and matrix, valuable insight can be gained into the mechanical properties of the composite material.

### CFRV Composites Preparation and Recyclability

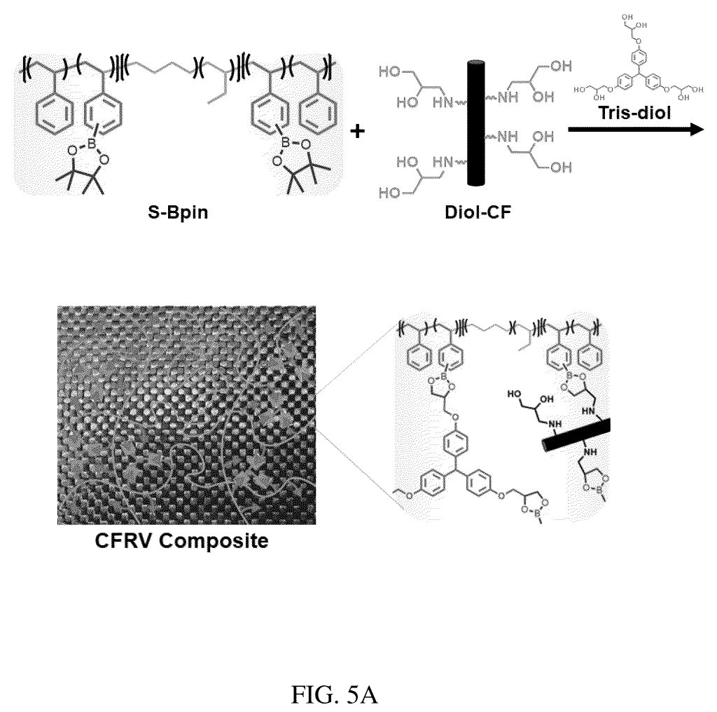

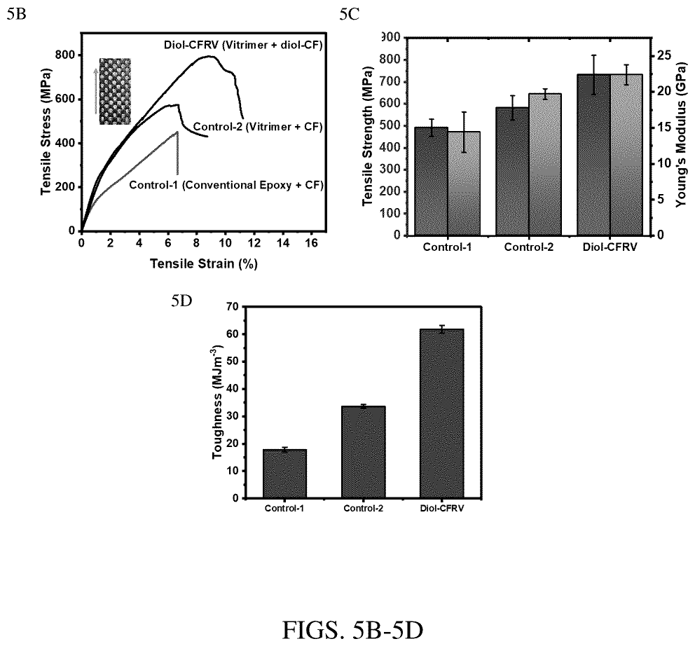

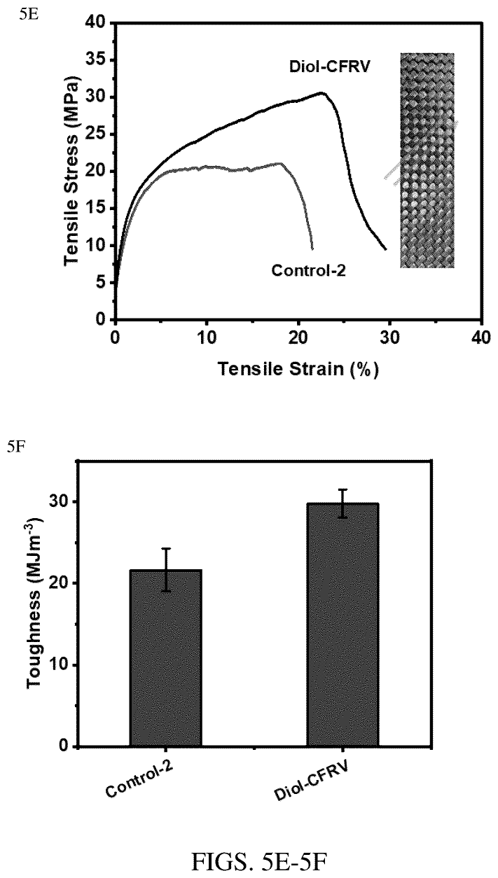

Using a biomimetic approach, a tough multiphase composite was developed by combining tris-diol_S-Bpin vitrimer with diol-CFs. The diol group in the CFs is covalently bonded with the vitrimer resin through dynamic boronic ester (B—O) bonding, as shown in FIG. 5A. The CFRV composites were fabricated by impregnating three layers of woven diol-CF mats in THF solution of tris-diol_S-Bpin and dried solvent under a high vacuum at 120° C. overnight. The dry composite samples are cured and hot-pressed at 200° C. for 30 minutes under 1 t pressure. The mechanical properties of diol-functionalized CF reinforced tris-diol_S-Bpin vitrimer (Diol-CFRV) composites were investigated at a vitrimer resin content of approximately ˜30 wt % (confirmed by the TGA) and compared with those of the composites made from conventional epoxy (control-1) and pristine-CF reinforced tris-diol_S-Bpin vitrimer (control-2) composites. As shown in FIG. 5B, the unidirectional tensile strengths of each CF composite were measured at a crosshead speed of 1 mm s⁻¹. Importantly, the ultimate tensile strength and modulus of diol-CFRV composites reached 731 MPa and 22.37 GPa respectively, which are 49%, and 55% higher than that of the conventional epoxy-based CFRP (control-1). This is likely attributed to the increased interfacial adhesion between the vitrimer resin and the fiber, while epoxy groups have minimal to no covalently bound functional groups with the fiber surface, as shown by the data in FIG. 5C. The unmodified CFRV composites (control-2) showed 26% lower tensile strength compared to the diol-CFRV, suggesting that fiber functionalization plays a vital role in increasing mechanical properties.

Moreover, the application of diol-functionalization on CFs leads to a remarkable enhancement in the toughness of diol-CFRV composites. Specifically, when compared to control-2, the toughness of the diol-functionalized CFRV composites increases by 84%, whereas when compared to control-1, the increase in toughness is a staggering 248%, as shown by the data in FIG. 5D. The diol-CFRV composites exhibited a significant improvement of 45% in interlaminar shear strength (ILSS) compared to the pristine CFRV, which indicates that the incorporation of diol to CFs and their interaction with the vitrimer matrix has a significant impact on the ILSS of the composite material.

To assess the interfacial adhesion between the fiber and matrix, the uniaxial tensile strength of 45-degree fiber-oriented CFRV composites was tested, and the resulting tensile stress and strain data, as shown in FIG. 5E, clearly indicate a significant (˜50%) increase in interfacial strength for the diol-CFRV composite as compared to the control-2 composite, thus validating the effectiveness of the functionalization process. The strong interfacial adhesion between fiber and matrix was also confirmed by the 38% higher toughness (the area underneath the tensile stress-strain curve) of diol-CFRV compared to control-2, as shown by the data in FIG. 5F. The tensile strength and strain data of diol-CFRV were compared with conventional epoxy-based CFRP and previously reported vitrimer-based CFRPs with CF fabric. Diol-CFRV showed remarkably high tensile strength, even rivaling or better than that of previously reported vitrimer-based CFRPs, which also demonstrates excellent toughness of diol-CFRV.

In addition, SEM images of the fractured surface of control-2 and diol-CFRV composites can help elucidate the interfacial bonding between fiber and matrix. The unmodified composite exhibited poor interfacial interaction with resin evidenced by the presence of loose CFs on the fractured surface, voids, and holes. These weak interfacial interactions and macrophase separation between the fiber and matrix was likely caused by the hydrophobicity of the unmodified CF surface, resulting in low mechanical performance of the composite. In contrast, diol-CF showed improved binding capability and interaction between the matrix and the fiber, enhanced fiber and the matrix the penetration, and reduced the formation of voids in the composites. The appearance of the bonded CF bundles and the solid interface between the diol-CF and resin indicate strong interfacial interaction and excellent wettability.

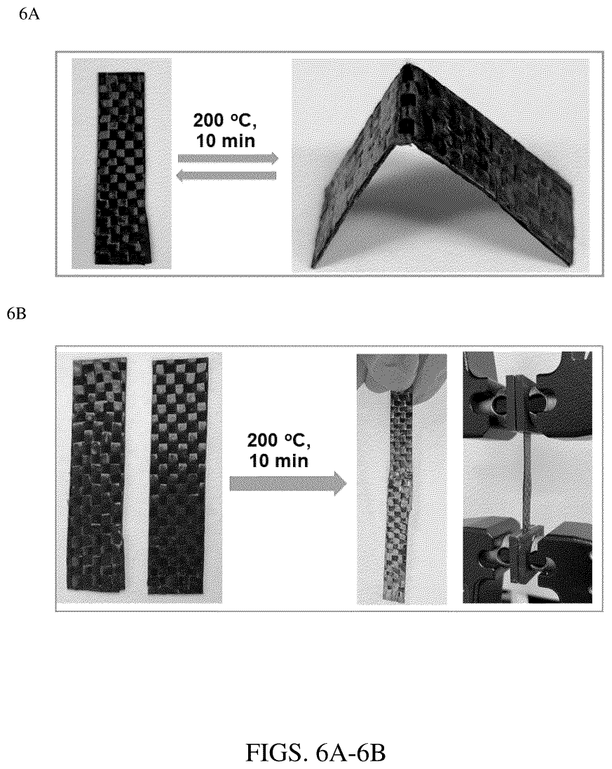

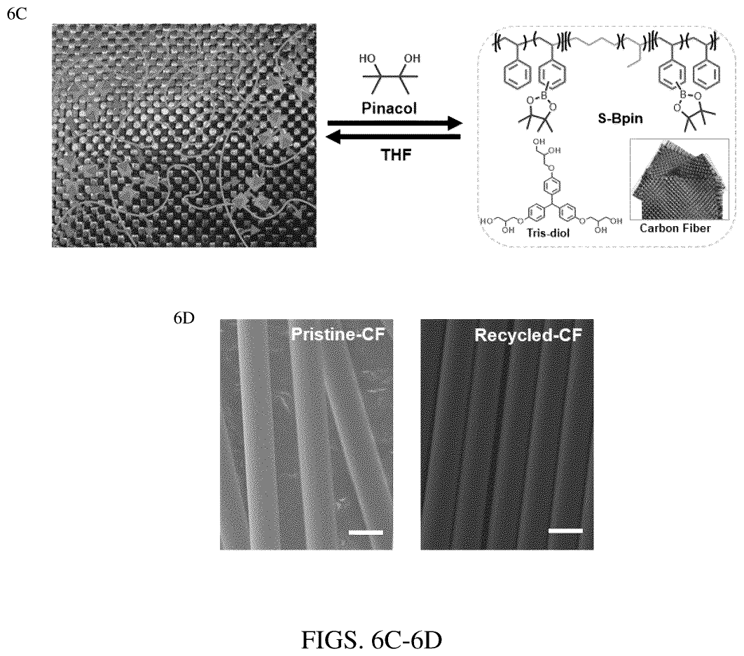

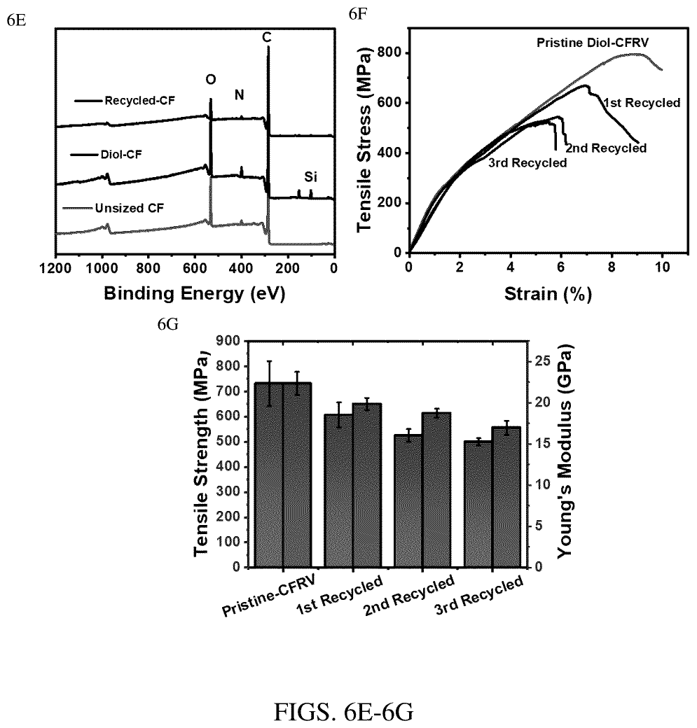

One of the advantages of vitrimer-based CFRV composites over thermosets is the thermoforming ability. Dynamic boronic ester exchange permits these composites to be molded or deformed into different shapes by simply applying heat. As schematically demonstrated in FIG. 6A, a rectangular composite sample was thermally deformed into a “V” shape at 200° C. The structural integrity of the “V” shape was maintained at room temperature until it was re-formed into its initial rectangular shape. The ability to mold and reshape materials using dynamic boronic ester exchange offers an attractive option for many industries including automotive which prioritize easy thermal processability.

The dynamic covalent bonds result in strong reversible adhesion with multiple interfaces. Dynamic boronic ester interaction in CFRV composites offers unprecedented levels of self-joining/adhesive capability, as schematically shown in FIG. 6B. The two composite samples were hot-pressed at 200° C. for 10 minutes and subjected to lap shear testing to analyze the extent to which they can be performed as self-adherents. The maximum lap shear strength was found to be 2 MPa, making them a good candidate for applications where the specimens need to be self-bound. The self-joining ability of the CFRV makes it an attractive option for many industries, particularly those in which it is desirable to replace mechanical fasteners and metals with lightweight materials (e.g., in automotive parts, aerospace parts, and wind turbines), as it can save extra costs of adhesives and fasteners.

As mentioned above, the tris-diol_S-Bpin vitrimer resin is chemically recyclable, and the polymer and the crosslinker can be recovered separately. Similar to the chemical recycling of tris-diol_S-Bpin vitrimer, the CFRV composites can be chemically recycled in the presence of pinacol and THF, as shown in the schematic in FIG. 6C. The composites were soaked in pinacol-THF solution at 65° C. overnight, where the vitrimer resin participates in exchange reactions with diol groups of pinacol, subsequently dissolving the polymer network. Similarly, the dynamic bonds formed with the fiber surface and the boronic ester groups can also be replaced with the pinacol. Therefore, introducing dynamic hydroxyl groups onto the fiber surface can completely recover the resin-free fiber. This is consistent with the SEM results, which further indicate that the resin is almost completely removed, as shown by the SEM images in FIG. 6D. In addition, the SEM images clearly illustrate no visible mechanical damage in either of the two CFs. Furthermore, the XPS data, as shown in FIG. 6E, also indicates that the recycled CF maintained their surface functionality. The CFs obtained after the chemical recycling were reused to fabricate the CFRV composites. After each cycle, the uniaxial tensile strength was re-measured, with the results shown in FIG. 6F. The tensile strength and the modulus were maintained within experimental error over at least three cycles, as shown by the data in FIG. 6G. Although the individual fibers were not mechanically damaged, the woven mats' fiber alignments may be changed during the experimental handling. Thus, the slight decline in the tensile values may be attributed to the fiber misalignment of the woven CFRP composites. These findings are encouraging as they suggest that the deconstruction, recycling, and processing of the carbon fiber did not cause any serious damage to its mechanical properties. Therefore, the closed-loop recycling of the carbon fiber from the composites was successfully achieved, and notably, without compromising its strength and modulus. Such closed-loop recycling of carbon fiber from composites has the potential to significantly reduce the environmental impact of the composites industry by diverting waste from landfills and reducing the need for newly produced materials.

### Glass Fiber Composites Preparation and Recyclability

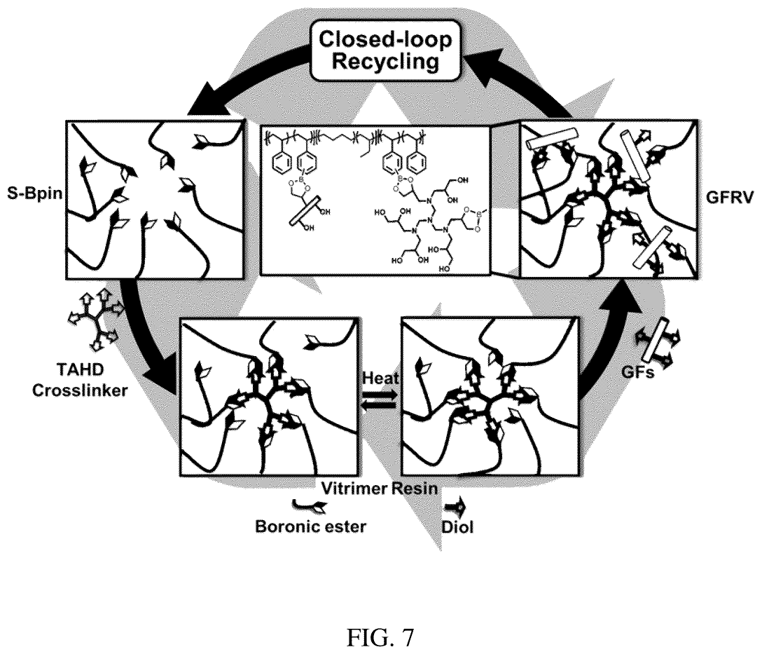

Analogous to CFRV composites, the above described vitrimer chemistry can be used for producing glass fiber reinforced vitrimer (GFRV) composites. The native hydroxyl groups on the surface of glass fibers permit their direct interaction with the boronic ester functionalized polymer and mitigate the delamination and recyclability issues of existing glass fiber reinforced polymer (GFRP) composites. The current GFRPs are mostly non-recyclable. Some GFRP composites are recycled by mechanical grinding and pyrolysis, but these weaken the fibers by up to 80%. Thus, there is a critical need for a closed-loop recycling method that maintains both the integrity of the glass fibers (GFs) and the resin. To address this, tough and closed-loop recyclable GFRV composites with exceptional interfacial adhesion were fabricated. This was achieved by introducing the same boronic ester-modified upcycled thermoplastic elastomer as described above, along with a new amine-based multi-diol crosslinker and neat glass fibers. A schematic of the GFRV composite production process is shown schematically in FIG. 7. The boronic ester-based vitrimer was prepared by crosslinking with tris aminohexadiol (TAHD) crosslinker, which has a better affinity for the GF surface. The TAHD crosslinker has six diol arms that readily create a dynamically crosslinked polymeric network with boronic esters group containing polymer.

The structure of the TAHD crosslinker is shown as follows:

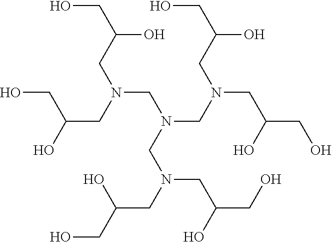 [SMILES: OCC(O)CN(CC(O)CO)CN(CN(CC(O)CO)CC(O)CO)CN(CC(O)CO)CC(O)CO]

The GFRV composites were prepared by impregnating woven S-Glass fibers in a solution of THF and crosslinked S-Bpin resin. The three-ply composites are fabricated by partial curing at 120° C. followed by hot pressing at 180° C. for 45 minutes. The dynamically crosslinked vitrimer resin is reinforced by the rich hydroxyl groups on unmodified glass fiber surfaces, facilitating the formation of dynamic covalent bonds with boronic ester groups. Unlike CFRV composites, which require modified fibers, the proposed GFRV composites are fabricated using unmodified GFs, providing a simpler approach to designing GF composites. This approach stands out for its innovative use of dynamic covalent bonds between the matrix and naturally occurring functional groups on the glass fiber surface, thus eliminating the need for surface modification. The dynamic boronic ester exchange between the resin and fiber interface results in robust mechanical properties, strong fiber-matrix interfacial adhesion, thermal reprocessing, and efficient closed-loop recycling of both fibers and resin, all of which addresses the challenge of end-of-life disposal of GFRP composites.

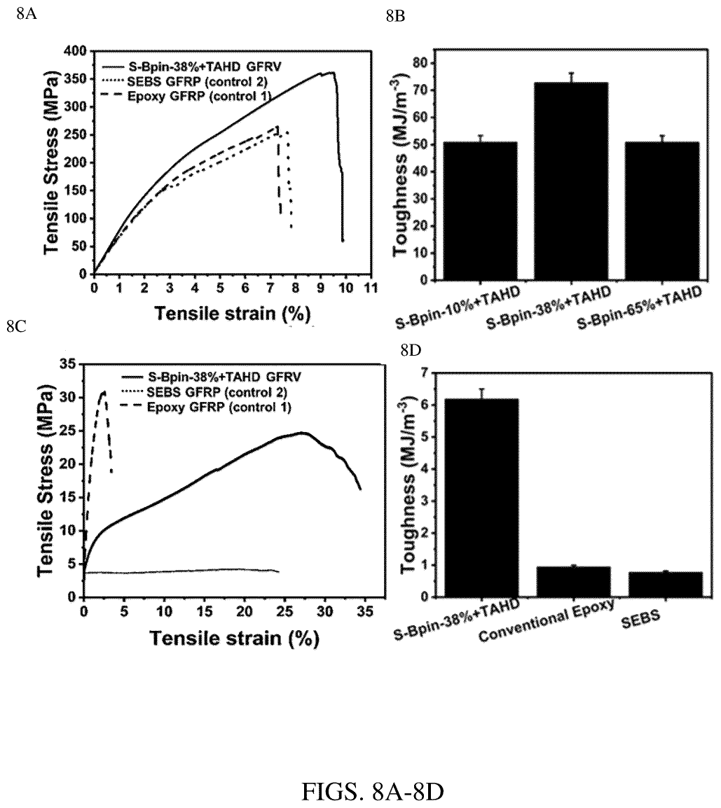

The prepared GFRV composites exhibit significantly enhanced interfacial adhesion and toughness as indicated by unidirectional and 45-degree tensile strain-stress properties. Notably, as shown by the data in FIGS. 8A and 8B, the ultimate tensile strength and toughness of GFRV composites reached 361±89.2 MPa and 6.2±1.4 MJ/m⁻³, respectively, which are 27% and 85% higher than that of the conventional epoxy-based GFRP (control-1). Conventional epoxy shows limited flexibility; thus, the further movement of the glass fiber will fracture the epoxy matrix, thereby resulting in lower elongated and toughened composites. The staggering increase in these mechanical properties is attributed to the increased interfacial adhesion between the vitrimer resin and the fiber. Unlike the GFRV composites, epoxy groups have minimal to no covalently bound functional groups with the GF surface.

As shown in FIGS. 8A and 8B, the GFRV composites exhibited a 30% and 79% increase in ultimate tensile strength and toughness, respectively, compared to control 2 with pristine SEBS matrix without boronic ester functionalization or crosslinker. These results further demonstrate that fiber-matrix adhesion plays a vital role in better mechanical properties, especially since SEBS, which has no exchangeable diol groups, cannot maintain good bonding between the fiber and the matrix. To evaluate the interfacial adhesion between the fiber and matrix, the uniaxial tensile strength of 45-degree fiber-oriented GFRVs was tested. As shown in FIGS. 8C and 8D, the resulting tensile stress and toughness data, respectively, indicate a significant increase of 500% and 693% in tensile stress and toughness compared to control 2 composites with the SEBS matrix. Although the conventional epoxy sample exhibited a 25% higher tensile stress than the GFRV composites, the fiber composites snapped immediately, thus resulting in a lower elongation. The GFRV exhibited excellent in-plane shear toughness with a 552% increase compared to the epoxy control. Although the rigidity of the epoxy matrix withstands higher stress while being stretched before breaking, the inability to maintain the flexibility resulted in a very low strain, thus reducing its toughness.

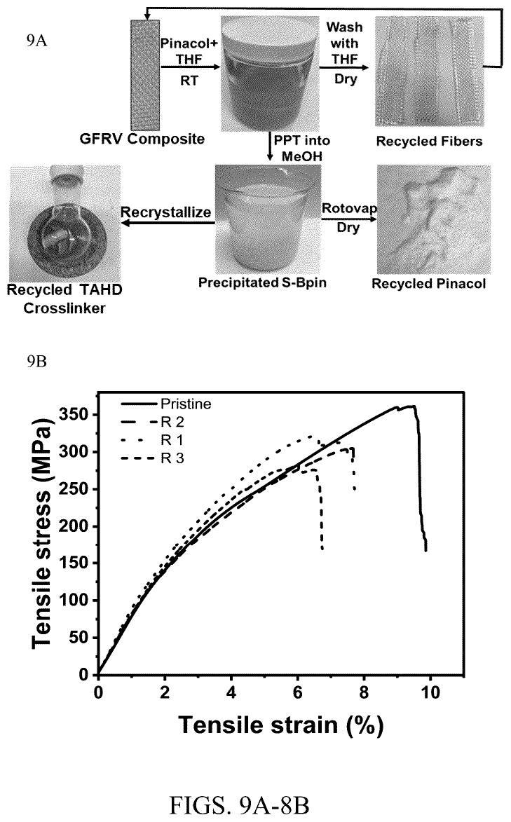

Moreover, similar to the closed-loop recycling method described for CFRV composites, GFRV composites are also closed-loop recyclable, thus permitting the recovery of all chemicals and fibers in their pristine form. FIG. 9A schematically illustrates the overall closed-loop recycling process for GFRV composites. Tensile testing of recycled composites resulted in maintained mechanical properties even after three complete recycling processes, with a slight decrease in toughness but no change in overall mechanical properties (within measurement error). The tensile stress-strain results of the recycled composites are shown in FIG. 9B. Overall, this approach provides a significant advancement in developing recyclable multifunctional structural materials. The strategy offers a sustainable alternative to non-recyclable thermoset GFRPs and also provides closed-loop circularity in composite materials.

### CONCLUSIONS

In summary, the present work demonstrates the successful development of a mechanically robust and fully recyclable carbon fiber reinforced vitrimer composite (CFRV) using a biomimetic hierarchical design approach. The commodity thermoplastic-based vitrimer resin produced herein exhibits outstanding strength and toughness and is further reinforced by a multidiol-functionalized carbon fiber. This unique fiber-matrix interaction is achieved through dynamic boronic ester covalent bonds and crosslinking with a multi-diol crosslinker, resulting in superior interfacial adhesion and tensile strength compared to unmodified CFRV and conventional epoxy CFRP composites. The incorporation of a dynamic multi-diol functional group not only enhances miscibility and wettability of the fiber with the matrix but also results in the formation of dynamic boronic ester bonds with the matrix, thereby improving the fiber-matrix adhesion. The use of dynamic boronic ester exchange also advantageously provides repairability, fast thermoformability, and self-adhesion of the CFRV composites. Furthermore, the modified fiber can be recovered and re-used without significant loss of mechanical properties, which provides complete closed-loop circularity in the system.

Similarly, the same boronic ester vitrimer chemistry can be applied to produce tough and closed-loop recyclable glass-fiber-reinforced vitrimer (GFRV) composites with exceptional mechanical properties. The boronic ester group forms dynamic covalent bonds with naturally occurring hydroxyl groups on GF surfaces, eliminating the need for surface modifications. This approach provides easy recyclability of GFs and resins, while enhancing mechanical performance. Overall, this work introduces a novel and sustainable method for recycling both the fiber and matrix, while also improving interfacial adhesion between the fiber and polymer matrix. With its outstanding mechanical properties and recyclability, these vitrimer composites have the potential to revolutionize advanced composites across various applications.

While there have been shown and described what are at present considered the preferred embodiments of the invention, those skilled in the art may make various changes and modifications which remain within the scope of the invention defined by the appended claims.

What is claimed is:

1. A dynamically crosslinked polymer composite material comprising:
(i) a polymer containing boronic acid or boronic ester groups; and
(ii) a solid filler embedded within the polymer, wherein surfaces of the solid filler are functionalized with hydroxy groups;
wherein the hydroxy groups on surfaces of the solid filler engage in dynamic crosslinking with the boronic acid or ester groups in the polymer.

2. The composite material of claim 1, further comprising:
(iii) polyol crosslinking molecules containing at least three hydroxy groups per polyol crosslinking molecule;
wherein the hydroxy groups in the polyol crosslinking molecules engage in dynamic crosslinking with the boronic acid or ester groups on the polymer, in addition to hydroxy groups on surfaces of the solid filler engaging in dynamic crosslinking with the boronic acid or ester groups on the polymer.

3. The composite material of claim 2, wherein the polyol crosslinking molecules are present in an amount of 1-50 mol % of boronic acid or ester groups.

4. The composite material of claim 2, wherein the polyol crosslinking molecules are present in an amount of 1-20 mol % of boronic acid or ester groups.

5. The composite material of claim 2, wherein the polyol crosslinking molecules are present in an amount of 1-10 mol % of boronic acid or ester groups.

6. The composite material of claim 2, wherein the polyol crosslinking molecules are present in an amount of 1-5 mol % of boronic acid or ester groups.

7. The composite material of claim 2, wherein the polyol crosslinking molecules contain at least four hydroxy groups per polyol crosslinking molecule.

8. The composite material of claim 2, wherein the polyol crosslinking molecules contain at least six hydroxy groups per polyol crosslinking molecule.

9. The composite material of claim 2, wherein the polyol crosslinking molecules have a molecular weight of no more than 2000 g/mol.

10. The composite material of claim 2, wherein the polyol crosslinking molecules have a molecular weight of no more than 1500 g/mol.

11. The composite material of claim 1, wherein the polymer is polystyrene-based and contains boronic acid or ester groups.

12. The composite material of claim 1, wherein the polymer is a copolymer of polystyrene and contains boronic acid or ester groups.

13. The composite material of claim 12, wherein the copolymer of polystyrene is a copolymer of polystyrene and a polyolefin, wherein the polyolefin is selected from the group consisting of polyethylene, polypropylene, polybutylene, polybutadiene, polyisoprene, and combinations thereof.

14. The composite material of claim 1, wherein the polymer comprises a vinyl, methacrylate-or acrylate-based polymer.

15. The composite material of claim 1, wherein the filler is comprised of fibers.

16. The composite material of claim 1, wherein the filler has a composition selected from carbon, metal oxide, biopolymer, and synthetic polymeric compositions.

17. The composite material of claim 1, wherein the filler has a carbon composition.

18. The composite material of claim 1, wherein the filler comprises carbon fibers having a thickness of at least 5 microns.

19. The composite material of claim 1, wherein the filler comprises woven carbon fibers.

20. The composite material of claim 1, wherein the filler comprises non-woven carbon fibers.

21. The composite material of claim 1, wherein the filler has a metal oxide composition.

22. The composite material of claim 21, wherein the metal oxide composition is glass or basalt.

23. The composite material of claim 22, wherein the glass or basalt is woven.

24. The composite material of claim 22, wherein the glass or basalt is non-woven.
